(19) United States
(12) Patent Application Publication
(10) Pub. No.: US 2021/0131641 A1
(43) Pub. Date: May 6, 2021

(54) LIGHT FLUX CONTROL MEMBER, LIGHT-EMITTING DEVICE AND SURFACE LIGHT SOURCE DEVICE

(71) Applicant: Enplas Corporation, Saitama (JP)

(72) Inventor: Kyouhei YAMADA, Saitama (JP)

(21) Appl. No.: 16/487,118

(22) PCT Filed: Feb. 15, 2018
(86) PCT No.: PCT/JP2018/005304

§ 371 Date: Aug. 20, 2019

(30) Foreign Application Priority Data
Feb. 20, 2017 (JP) 2017-028917

(51) Int. Cl. F21V 7/04; F21V 13/04

(52) U.S. Cl. CPC F21V 7/041; F21Y 2103/10; F21V 13/04

(57) ABSTRACT

A light flux control member comprises a surface of incidence, which is the inner surface of a concave portion disposed on the back side, having an inner side surface and an inner ceiling surface; two reflective surfaces disposed on the front side, whereby a portion of the light incident on at least the inner ceiling surface is reflected in two directions, which are approximately perpendicular to the optical axis of the light-emitting element; and two light emission surfaces, disposed with the two reflective surfaces therebetween, wherefrom the light reflected by the two reflective surfaces and the light incident on the inner side surface are respectively emitted to the exterior. Each of the two light emission surfaces has, disposed in a region reached directly by light incident on either of the inner side surfaces, a first sloped surface that approaches the optical axis as the X-axis is approached.

### TECHNICAL FIELD

The present invention relates to a light flux controlling member, a light emitting device and a surface light source device.

### BACKGROUND ART

Some transmission type image display apparatuses such as liquid crystal display apparatuses use a direct surface light source device as a backlight. In recent years, direct surface light source devices having a plurality of light emitting elements as the light source have been used.

For example, a direct surface light source device includes a substrate, a plurality of light emitting elements, a plurality of light flux controlling members (lenses) and a light diffusion member. The light emitting element is a light-emitting diode (LED) such as a white light-emitting diode, for example. The plurality of light emitting elements are disposed in a matrix on a substrate (e.g., a plurality of lines each of which includes a plurality of light emitting elements are disposed). The light flux controlling member that expands the light of the light emitting element in the plane direction of the substrate is disposed over each light emitting element. The light emitted from the light flux controlling member is diffused by the light diffusion member so as to illuminate an illumination member (e.g., a liquid crystal panel) in a planar fashion.

As a conventional light flux controlling member, PTL 1 discloses light direction conversion device 10 including light emitting element 40, light incidence surfaces 12b and 12c configured to allow incidence of light emitted from light emitting element 40, light-reflecting surface 12d configured to totally reflect light having been entered from light incidence surfaces 12b and 12c, and light emission surface 12e configured to laterally emit light reflected by light-reflecting surface 12d as illustrated in FIG. 1, for example. PTL 1 also discloses that the uniformity of the luminance of light emitted from light direction conversion device 10 is increased by forming light direction conversion device 10 with a transparent resin containing light diffusion member 14 such that a part of light is emitted from light-reflecting surface 12d.

Incidentally, in recent years, from the viewpoint of manufacturing a large surface light source device at low cost, reduction in number of light emitting elements (e.g., reduction in number of lines each including a plurality of light emitting elements) is desired. That is, it is desired to deliver light to corners of the surface light source device even with a reduced number of lines of a plurality of light emitting elements. Under such a circumstance, it is desired to deliver light emitted from light emitting element as far as possible in a light flux controlling member.

### CITATION LIST

### Patent Literature

PTL 1

Japanese Patent Application Laid-Open No. 2015-181131

### SUMMARY OF INVENTION

### Technical Problem

In light direction conversion device 10 disclosed in PTL 1, however, a large quantity of light is emitted upward from light-reflecting surface 12d, and downward from emission surface 12e. The downward light from light emission surface 12e is reflected by the substrate surface in a region around light emission surface 12e so as to be directed upward. As such, the brightness of the luminance may become excessively high in a region around light direction conversion device 10 in addition to insufficiency of light delivered to a remote location from light emitting element 40, thus leading to luminance unevenness.

In addition, to deliver light to corners of the surface light source device even with a reduced number of light emitting elements (a reduced number of lines including a plurality of light emitting element), it is desirable that the light flux controlling member have a light distribution property for expanding light in the longitudinal direction (the opposing direction of two light emission surfaces 12e) (or it is desirable that an anisotropic light distribution property be provided). If light is excessively expanded in the longitudinal direction (or if an excessive anisotropic light distribution property is provided), however, light expansion in the short direction (the extending direction of light emission surface 12e) is reduced. Consequently, it is difficult to deliver light to the four corners of the surface light source device, and luminance unevenness may be caused between the center portion and the four corners in the surface light source device.

An object of the present invention is to provide a light flux controlling member capable of suppressing luminance unevenness caused by downward light from an emission surface while delivering light to a remote location. More preferably, a light flux controlling member is provided that can reduce luminance unevenness between the center portion and corner portions while maintaining the light distribution property. In addition, another object of the present invention is to provide a light emitting device and a surface light source device including the above-mentioned light flux controlling member.

### Solution to Problem

A light flux controlling member according to the present invention is configured to control a distribution of light emitted from a light emitting element, the light flux controlling member including: an incidence surface that is an inner surface of a recess and includes an inner side surface and an inner top surface, the recess being disposed on a rear side to intersect an optical axis of the light emitting element, the incidence surface being configured to allow entrance of light emitted from the light emitting element; two reflection surfaces disposed on a front side and configured to reflect at least a part of light entered from the inner top surface in two directions that are substantially opposite to each other and are substantially perpendicular to the optical axis of the light emitting element; and two emission surfaces disposed opposite to each other in an X-axis direction extending from a light emission center of the light emitting element along the two directions so as to sandwich the two reflection surfaces, the two emission surfaces being configured to emit, to outside, light reflected by the two reflection surfaces and light entered from the inner side surface. The emission surface includes a first inclined surface disposed in a region where the light entered from the inner side surface directly reaches, the first inclined surface being inclined toward the optical axis in a direction toward the X axis.

A light emitting device according to the present invention includes: a light emitting element; and the light flux controlling member. The incidence surface is disposed to intersect the optical axis of the light emitting element.

A surface light source device according to the present invention includes: a plurality of the light emitting devices; and a light diffusion plate configured to allow light emitted from the light emitting devices to pass therethrough while diffusing the light.

### BRIEF DESCRIPTION OF DRAWINGS

FIG. 1 illustrates a configuration of a conventional light emitting device;

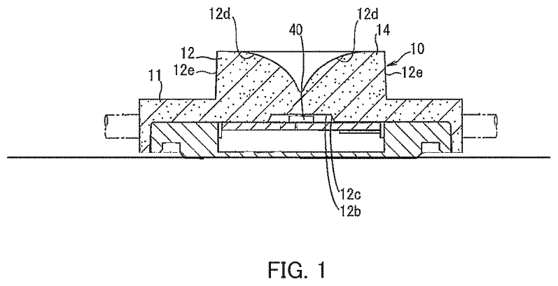

FIGS. 2A and 2B illustrate a configuration of a surface light source device according to Embodiment 1;

FIGS. 3A and 3B illustrate a configuration of the surface light source device according to Embodiment 1;

FIG. 4 is an enlarged sectional view illustrating a part of FIG. 3B;

FIGS. 5A to 5C illustrate a configuration of the light flux controlling member according to Embodiment 1;

FIGS. 6A to 6C illustrate a configuration of the light flux controlling member according to Embodiment 1;

FIGS. 7A to 7C illustrate a configuration of a comparative light flux controlling member;

FIG. 8 illustrates a result of an analysis of light paths of light beams entered from an inner side surface of a light flux controlling member in a comparative surface light source device provided with the light flux controlling member illustrated in FIG. 7;

FIGS. 9A and 9B illustrate a result of an analysis of light paths of beams entered from an inner top surface of the light flux controlling member in the comparative surface light source device provided with the light flux controlling member illustrated in FIG. 7;

FIGS. 10A and 10B illustrate a result of an analysis of light paths of light beams entered from the inner top surface of light flux controlling member in the comparative surface light source device provided with the light flux controlling member illustrated in FIG. 7;

FIG. 11 illustrates a result of an analysis of light paths of light beams entered from the inner side surface of the light flux controlling member in the surface light source device provided with the light flux controlling member according to Embodiment 1;

FIGS. 12A and 12B illustrate a result of an analysis of light paths of light beams entered from the inner top surface of light flux controlling member in the surface light source device provided with the light flux controlling member according to Embodiment 1;

FIGS. 13A and 13B illustrate a result of an analysis of light paths of light beams entered from the inner top surface of light flux controlling member in the surface light source device provided with the light flux controlling member according to Embodiment 1;

FIG. 14 illustrates analysis results of an illuminance distribution on a light diffusion plate in the surface light source device provided with the light flux controlling member according to Embodiment 1, and a surface light source device provided with the comparative light flux controlling member;

FIGS. 15A and 15B illustrate a configuration of the light flux controlling member according to Embodiment 2;

FIGS. 16A to 16C illustrate a configuration of the light flux controlling member according to Embodiment 2;

FIGS. 17A to 17C illustrate a configuration of the light flux controlling member according to Embodiment 2;

FIGS. 18A and 18B are perspective views illustrating configurations of a first emission surface, a second emission surface and a third emission surface;

FIGS. 19A and 19B illustrate a result of an analysis of light paths of light beams entered from the inner top surface of light flux controlling member in a surface light source device provided with the light flux controlling member according to Embodiment 2;

FIGS. 20A and 20B illustrate a result of an analysis of light paths of light beams entered from the inner top surface of light flux controlling member in the surface light source device provided with the light flux controlling member according to Embodiment 2;

FIGS. 21A and 21B are graphs illustrating analysis results of the illuminance distribution on a light diffusion plate in surface light source devices provided with light flux controlling members A-1 to A-4 according to Embodiment 2;

FIGS. 22A and 22B are graphs illustrating analysis results of the illuminance distribution on a light diffusion plate in surface light source devices provided with light flux controlling members B-1 to B-4 according to Embodiment 2;

FIGS. 23A and 23B are graphs illustrating analysis results of the illuminance distribution on a light diffusion plate in surface light source devices provided with light flux controlling members C-1 to C-4 according to Embodiment 2;

FIGS. 24A and 24B are graphs illustrating analysis results of the illuminance distribution on a light diffusion plate in surface light source devices provided with light flux controlling members D-1 to D-4 according to Embodiment 2;

FIGS. 25A and 25B illustrate a configuration of a light flux controlling member according to Embodiment 3;

FIGS. 26A to 26C illustrate a configuration of the light flux controlling member according to Embodiment 3;

FIGS. 27A to 27C illustrate a configuration of the light flux controlling member according to Embodiment 3;

FIGS. 28A and 28B are diagrams for describing configurations of a first reflection surface and a second reflection surface;

FIGS. 29A and 29B illustrate a result of an analysis of light paths of light beams entered from the inner top surface of light flux controlling member in a surface light source device provided with the light flux controlling member according to Embodiment 3;

FIGS. 30A and 30B illustrate a result of an analysis of light paths of light beams entered from the inner top surface of light flux controlling member in the surface light source device provided with the light flux controlling member according to Embodiment 3;

FIG. 31 illustrates analysis results of an illuminance distribution on a light diffusion plate in the surface light source device provided with the light flux controlling member according to Embodiment 3, and the surface light source device provided with the light flux controlling member according to Embodiment 1; and

FIG. 32 illustrates analysis results of normalized luminance distribution in the surface light source device provided with the light flux controlling member according to Embodiment 3, the surface light source device provided with the light flux controlling member according to Embodiment 1, and the surface light source device provided with the light flux controlling member according to Embodiment 2.

### DESCRIPTION OF EMBODIMENTS

Embodiments of the present invention are elaborated below with reference to the accompanying drawings.

### Embodiment 1

### Configuration of Surface Light Source Device

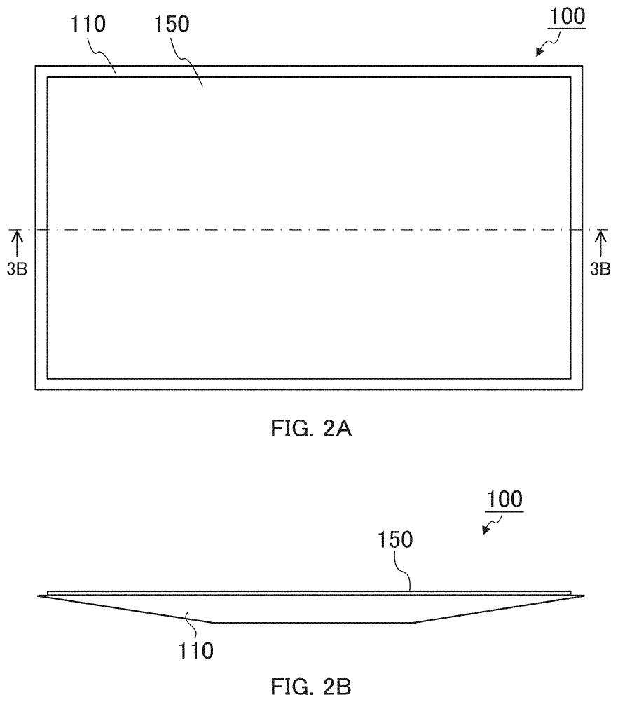

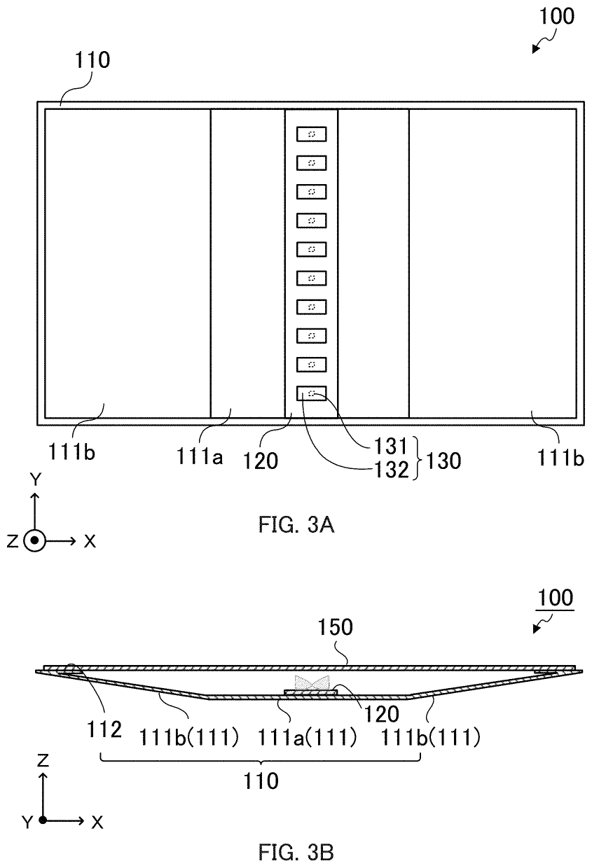

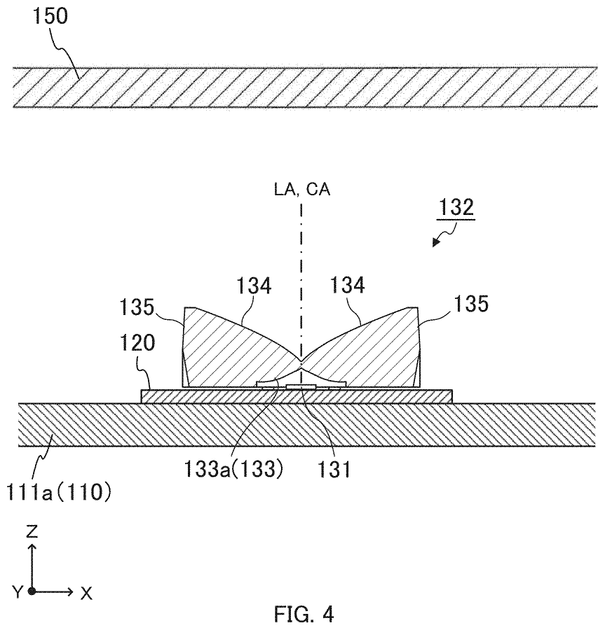

FIGS. 2A to 3B illustrate a configuration of surface light source device 100 according to Embodiment 1. FIG. 2A is a plan view of surface light source device 100, and FIG. 2B is a front view of surface light source device 100. FIG. 3A is a plan view illustrating a state where light diffusion plate 150 is omitted in FIG. 2A, and FIG. 3B is a sectional view of taken along line 3B-3B of FIG. 2A. FIG. 4 is an enlarged sectional view illustrating a part of FIG. 3B.

As illustrated in FIGS. 2A to 3B, surface light source device 100 includes housing 110, substrate 120, a plurality of light emitting devices 130 and light diffusion plate 150.

Housing 110 is a box for housing substrate 120 and a plurality of light emitting devices 130 therein. At least a part of one side of housing 110 is open. Housing 110 is composed of bottom plate 111, and top plate 112 opposite to bottom plate 111. Bottom plate 111 includes horizontal part 111a parallel to top plate 112, and inclined parts 111b inclined to top plate 112 with horizontal part 111a therebetween. Inclined part 111b reflects, toward light diffusion plate 150, light emitted from light emitting device 130 in an approximately horizontal direction such that the light emitted from light emitting device 130 can be readily collected at light diffusion plate 150. In addition, with housing 110 having the above-mentioned shape, the thickness of the external appearance of surface light source device 100 can be reduced. In top plate 112, an opening of a rectangular shape that serves as a light emission region is formed. The size of the opening corresponds to the size of the light emission region formed in light diffusion plate 150, and is, for example, 400 mm×700 mm (32 inch). This opening is closed with light diffusion plate 150. The height (space thickness) from the surface of bottom plate 111a to light diffusion plate 150 is, but not limited to, about 10 to 40 mm Housing 110 is composed of a resin such as polymethylmethacrylate (PMMA) and polycarbonate (PC), a metal such as stainless steel and aluminum, or the like, for example.

Substrate 120 is a flat plate disposed on bottom plate 111 of housing 110 and is configured to dispose a plurality of light emitting devices 130 at a predetermined interval in housing 110. The surface of substrate 120 is configured to reflect, toward light diffusion plate 150, light arriving from light emitting device 130.

Light emitting devices 130 are disposed on substrate 120 in a line. The number of light emitting devices 130 disposed on substrate 120 is not limited. The number of light emitting devices 130 disposed on substrate 120 is appropriately set based on the size of the light emission region (light emitting surface) defined by the opening of housing 110.

Each light emitting device 130 includes light emitting element 131 and light flux controlling member 132. Each light emitting device 130 is disposed such that the optical axis of light emitted from light emitting element 131 (light axis LA of light emitting element 131 described later) is aligned with the normal to the surface of substrate 120.

Light emitting element 131 is the light source of surface light source device 100 (and light emitting device 130). Light emitting element 131 is disposed on substrate 120. Light emitting element 131 is a light-emitting diode (LED), for example. The color of light emitted from light emitting element 131 included in emitting device 130 is not limited.

Light flux controlling member 132 controls the distribution of light emitted from light emitting element 131 such that the travelling direction of the light is changed to two directions that are substantially opposite to each other and approximately perpendicular to light axis LA of light emitting element 131 (which correspond to the positive and negative directions of the X axis described later). Light flux controlling member 132 is disposed over light emitting element 131 in such a manner that light axis LA of light flux controlling member 132 matches central axis CA of light emitting element 131 (see FIG. 4). The “light axis LA of light emitting element 131” refers to a central light beam of a stereoscopic light flux from light emitting element 131. The “central axis CA of light flux controlling member 132” refers to a symmetric axis of 2-fold rotational symmetry, for example.

In the following description, regarding each light emitting device 130, with respect to the light emission center of light emitting element 131 as the origin, the Z axis is an axis parallel to light axis LA of light emitting element 131, the Y axis is an axis that is parallel to the direction in which the plurality of light emitting devices 130 are arranged in a virtual plane that is orthogonal to the Z axis and includes the light emission center of light emitting element 131, and the X axis is an axis orthogonal to the Y axis in the virtual plane. Also, first virtual plane P1 is a virtual plane including light axis LA and the X axis (XZ plane), second virtual plane P2 is a virtual plane including light axis LA and the Y axis (YZ plane), and third virtual plane P3 is a virtual plane including the X axis and the Y axis (XY plane). In Embodiment 1, light flux controlling member 132 is plane symmetrical with respect to first virtual plane P1 (XZ plane) and second virtual plane P2 (YZ plane), and is rotationally symmetrical about the X axis.

The material of light flux controlling member 132 is not limited as long as light of a desired wavelength can pass therethrough. Examples of the material of light flux controlling member 132 include: optically transparent resins such as polymethylmethacrylate (PMMA), polycarbonate (PC), and epoxy resin (EP); and glass.

A main feature of surface light source device 100 according to Embodiment 1 is the configuration of light flux controlling member 132. Therefore, details of light flux controlling member 132 will be described later.

Light diffusion plate 150 is disposed to close the opening of housing 110. Light diffusion plate 150 is a plate-shaped member having optical transparency and a light diffusing property, and allows light emitted from emission surface 135 of light flux controlling member 132 to pass therethrough while diffusing the light. Light diffusion plate 150 can serve as a light emitting surface of surface light source device 100, for example.

The material of light diffusion plate 150 is not limited as long as light emitted from emission surface 135 of light flux controlling member 132 can be allowed to pass therethrough while being diffused. For example, light diffusion plate 120 is formed of an optically transparent resin such as polymethylmethacrylate (PMMA), polycarbonate (PC), polystyrene (PS), and styrene methyl methacrylate copolymerization resin (MS). In order to provide a light diffusing property, minute irregularities are formed on the surface of light diffusion plate 150, or diffusing members such as beads are dispersed in light diffusion plate 150.

In surface light source device 100 according to Embodiment 1, light emitted from each light emitting element 131 is emitted by light flux controlling member 132 so as to illuminate a wide range of light diffusion plate 150, i.e., the light is changed to light travelling in two directions that are substantially opposite to each other (X-axis direction in FIG. 4) and are approximately perpendicular to axis LA of light emitting element 131. Light emitted from each light flux controlling member 132 is further diffused by light diffusion plate 150, and emitted to the outside. Thus, luminance unevenness of surface light source device 100 can be reduced.

### Configuration of Light Flux Controlling Member

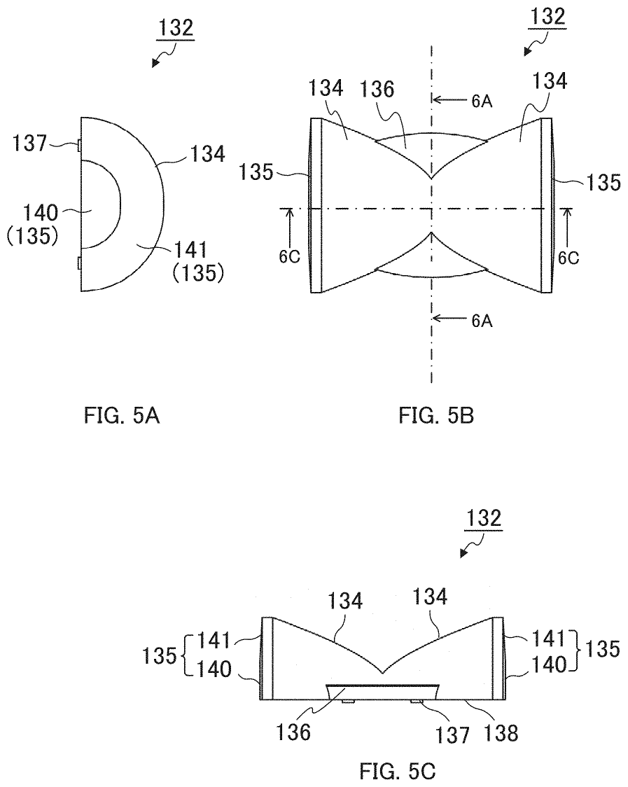

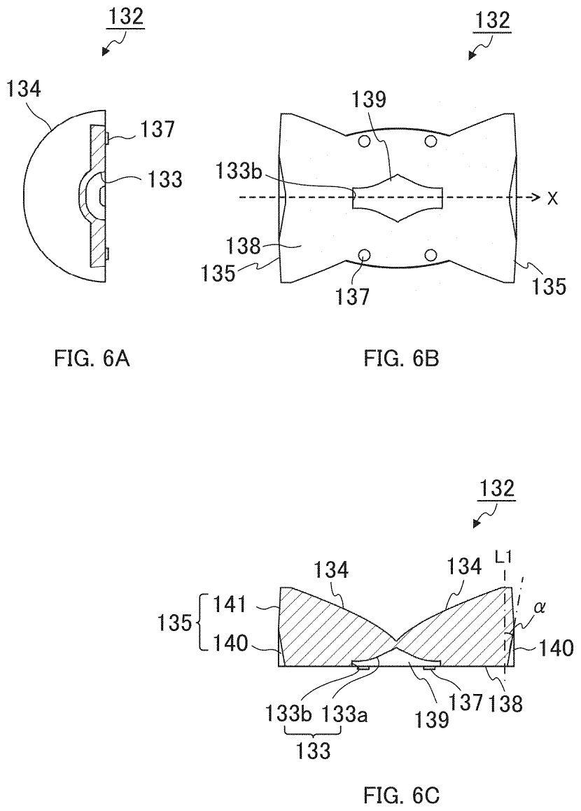

FIGS. 5A to 6C illustrate a configuration of light flux controlling member 132. FIG. 5A is a side view of light flux controlling member 132, FIG. 5B is a plan view of light flux controlling member 132, and FIG. 5C is a front view of light flux controlling member 132. FIG. 6A is a sectional view taken along line 6A-6A of FIG. 5B, FIG. 6B is a bottom view, and FIG. 6C is a sectional view taken along line 6C-6C of FIG. 5B.

Light flux controlling member 132 controls the distribution of light emitted from light emitting element 131. As illustrated in FIGS. 6A to 6C, light flux controlling member 132 includes incidence surface 133, two reflection surfaces 134, two emission surfaces 135, two flange parts 136 and four leg parts 137.

Incidence surface 133 allows incidence of light emitted from light emitting element 131. Incidence surface 133 is an inner surface of recess 139 formed at a center portion of bottom surface 138 (the surface on the light emitting element 131 side, i.e., the rear side) of light flux controlling member 132. Recess 139 includes inner top surface 133a and inner side surface 133b. Inner top surface 133a may be composed of one or more surfaces. Inner side surface 133b is composed of two or more surfaces. In Embodiment 1, the inner surface (incidence surface 133) of recess 139 includes two (a pair of) inner top surfaces 133a, and two (a pair of) inner side surfaces 133b disposed opposite to each other in the X-axis direction. Recess 139 may further include another surface.

The shape of inner top surface 133a may be, but not limited to, a planar surface or a curved surface. Preferably, in the cross section including the X axis, inner top surface 133a is a curved surface protruding to the rear side so that light entered from inner top surface 133a easily reaches two reflection surfaces 134. Inner side surface 133b may be a planar surface, or a curved surface. In Embodiment 1, inner side surface 133b is a planar surface.

Two reflection surfaces 134 are disposed on the side (the surface on light diffusion plate 150 side, i.e., the front side) opposite to light emitting element 131 with incidence surface 133 therebetween. In addition, two reflection surfaces 134 reflect at least a part of light entered from inner top surface 133a in two directions (corresponding to the positive and negative directions along the X axis) that are substantially opposite to each other and are substantially perpendicular to light axis LA of light emitting element 131. Two reflection surfaces 134 are formed in a shape in which the surfaces are separated away from the X axis in the direction away from light axis LA. Specifically, in the cross section including light axis LA of light emitting element 131, two reflection surfaces 134 has a shape in which the inclination of the tangent thereto gradually decreases (so as to be parallel to the X axis) in the direction toward the end portion (emission surface 135) from light axis LA of light emitting element 131.

Two emission surfaces 135 are disposed opposite to each other in the direction of the X axis (the axis extending along the above-mentioned two directions with the light emission center of light emitting element 131 as the origin) with two reflection surfaces 134 therebetween. Specifically, it is preferable that two emission surfaces 135 be disposed such that the lower end thereof is located on the X axis or on the front side relative to the X axis. Two emission surfaces 135 emit, to the outside, light entered from inner side surface 133b and directly reached the emission surface 135, and light entered from inner top surface 133a and reflected by reflection surface 134. In addition, for the purpose of reducing downward light, each emission surface 135 includes first inclined surface 140 disposed in a region where light entered from inner side surface 133b directly reaches emission surface 135.

First inclined surface 140 is an inclined surface inclined toward light axis LA in the direction toward the X axis. Preferably, first inclined surface 140 is a rotationally symmetrical surface about the X axis or a straight line obtained by translating the X axis in the Z-axis direction. Preferably, as illustrated in FIG. 6C, inclination angle α of first inclined surface 140 with respect to first virtual line L1 orthogonal to the X axis is 3 to 15°, more preferably, 5 to 10°. When Inclination angle α of first inclined surface 140 with respect to first virtual line L1 is 3° or greater, the light having reached first inclined surface 140 can be readily emitted upward. When Inclination angle α of first inclined surface 140 with respect to first virtual line L1 is 15° or smaller, total reflection at first inclined surface 140 of the light having reached first inclined surface 140 can be reduced without excessively emitting upward the light having reached first inclined surface 140, and it is thus possible to prevent excessive brightness in a region around light emitting device 130 on light diffusion plate 150 illuminated with light emitted from light emitting device 130. The illuminance distribution and/or the range of the irradiation region is adjusted in accordance with the thickness and/or size of surface light source device 100, and accordingly inclination angle α is also appropriately adjusted in accordance with the thickness and/or size of surface light source device 100.

First inclined surface 140 may be an inclined surface linearly inclined toward light axis LA in the direction toward the X axis, or may be a curved inclined surface inclined toward light axis LA in the direction toward the X axis. In the case where first inclined surface 140 is a curved inclined surface inclined toward light axis LA in the direction toward the X axis, the inclination angle, with respect to first virtual line L1, of the straight line connecting the outer periphery of first inclined surface 140 and the intersection of first inclined surface 140 and the X axis is set to inclination angle α of first inclined surface 140 with respect to first virtual line L1.

Preferably, two emission surfaces 135 further include vertical surface 141 disposed in a region where light entered from inner top surface 133a and reflected by reflection surface 134 reaches emission surface 135. Vertical surface 141 is substantially parallel to light axis LA, and may be a planar surface, or a curved surface. The term “substantially parallel to light axis LA” means that the angle of vertical surface 141 with respect to light axis LA is ±3° or smaller, preferably, 0°.

Two flange parts 136 are located between two reflection surfaces 134 in a region around light axis LA, and are protruded outward with respect to light axis LA. Flange part 136 is not an essential component; however, by providing flange part 136, the ease of the handling and alignment of light flux controlling member 132 increases. If necessary, flange part 136 may have a shape capable of controlling and emitting light incident on flange part 136.

Four leg parts 137 are substantially columnar shaped members protruding from bottom surface 138 to the rear side in an outer periphery portion of bottom surface 138 (rear surface) of light flux controlling member 132. Leg parts 137 support light flux controlling member 132 at an appropriate position with respect to light emitting element 131 (see FIG. 6B). Leg part 137 may be fitted in holes formed in substrate 120 so as to be used for positioning. In addition, the position, shape, and number of leg parts 137 are not limited as long as light flux controlling member 132 can be stably fixed to substrate 120 so as to prevent negative optical influence.

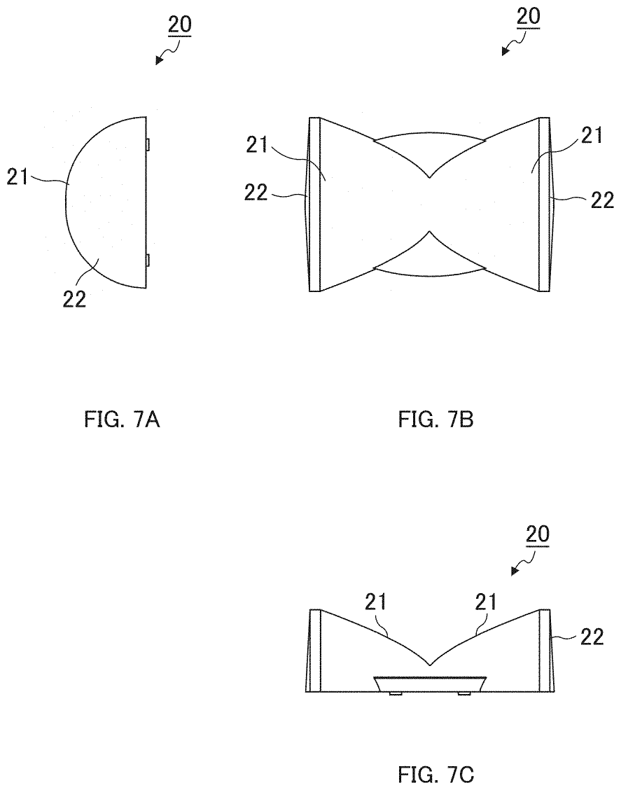

Operations of light flux controlling member 132 according to Embodiment 1 are described in comparison with a comparative light flux controlling member. FIGS. 7A to 7C illustrate a configuration of a comparative light flux controlling member. FIG. 7A is a side view of comparative light flux controlling member 20, FIG. 7B is a plan view of comparative light flux controlling member 20, and FIG. 7C is a front view of comparative light flux controlling member 20.

In comparative light flux controlling member 20, light emitted from light emitting element 131 is entered from the incidence surface (not illustrated in the drawing). The light entered from an inner top surface (not illustrated in the drawing) of the incidence surface (not illustrated in the drawing) is reflected by two reflection surfaces 21 so as to travel in two substantially opposite directions substantially perpendicular to light axis LA of the light emitting element, and to reach two emission surfaces 22. On the other hand, light entered from an inner side surface (not illustrated in the drawing) of the incidence surface (not illustrated in the drawing) directly reaches two emission surfaces 22. The light having reached two emission surfaces 22 is emitted from two emission surfaces 22.

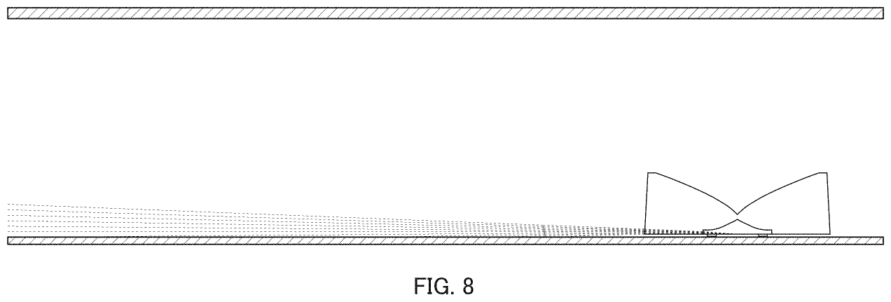

Here, two emission surfaces 22 are composed of vertical surfaces substantially parallel to light axis LA, and two emission surfaces 22 do not include first inclined surface 140 (see FIG. 7A). Accordingly, the majority of the light emitted from a region where light entered from the inner side surface (not illustrated in the drawing) directly reaches emission surface 22 advances downward, and is reflected by a reflection sheet in the case where the reflection sheet is disposed around substrate 120, and/or by the surface of substrate 120 in the case where substrate 120 has a large planar dimension. As a result, the diffusely-reflected light easily reaches the illumination surface in a region around immediately above light emitting device 130, and a region around light emitting device 130 becomes excessively bright, and, luminance unevenness is easily caused (see FIG. 8).

In contrast, in light flux controlling member 132 according to Embodiment 1, light emitted from light emitting element 131 is entered from incidence surface 133. The light entered from inner top surface 133a of incidence surface 133 is reflected by two reflection surfaces 134 so as to travel in two directions that are substantially opposite to each other and are substantially perpendicular to light axis LA of light emitting element 131, and to reach two emission surfaces 135. On the other hand, the light entered from inner side surface 133b of incidence surface 133 directly reaches two emission surfaces 135. The light having reached two emission surfaces 135 is emitted from two emission surfaces 135.

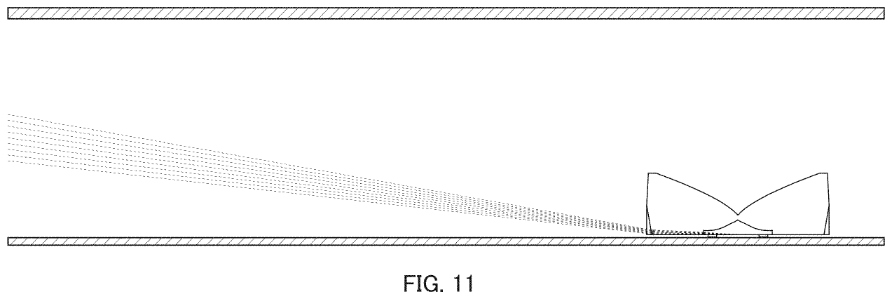

Here, each of two emission surfaces 135 includes first inclined surface 140 in a region where light entered from inner side surface 133b directly reaches emission surface 135 (see FIG. 5A). The majority of the light emitted from first inclined surface 140 is refracted upward (see FIG. 11). Thus, the light that is emitted downward from emission surface 135 can be reduced, and the light that is reflected by the surface of substrate 120 can be reduced. As a result, the region around light emitting device 130 does not become excessively bright, and the light emitted from first inclined surface 140 easily reaches a remote position, and thus, luminance unevenness can be reduced.

### Simulation 1

In Simulation 1, light paths and the illuminance distribution on light diffusion plate 150 in the light flux controlling member according to Embodiment 1 (light flux controlling member 132 illustrated in FIGS. 5A to 6C) were analyzed. The light paths and the illuminance distribution on light diffusion plate 150 were analyzed with surface light source device 100 provided with only one light emitting device 130.

Also, for comparison, the light paths and the illuminance distribution on the light diffusion plate were analyzed with a surface light source device provided with a comparative light flux controlling member (light flux controlling member 20 of FIGS. 7A to 7C) that is identical to light flux controlling member 132 illustrated in FIGS. 5A to 6C except that first inclined surface 140 is not provided in two emission surfaces 135.

### Parameters

Outer diameter of light flux controlling member: 25 mm in X-axis direction and 18 mm in Y-axis direction

Height of light emitting element: 8.4 mm

Size of light emitting element: a substantially square shape with each side of 1.6 mm

Distance between substrate 120 and light diffusion plate 150: 30 mm

Inclination angle α of first inclined surface 140 with respect to first virtual line L1: 10°

FIG. 8 illustrates analysis results of light paths of light beams entered from an inner side surface of light flux controlling member 20 (light beams emitted at an angle of 86 to 90° with respect to light axis LA in front view) in a comparative surface light source device provided with light flux controlling member 20 illustrated in FIG. 7.

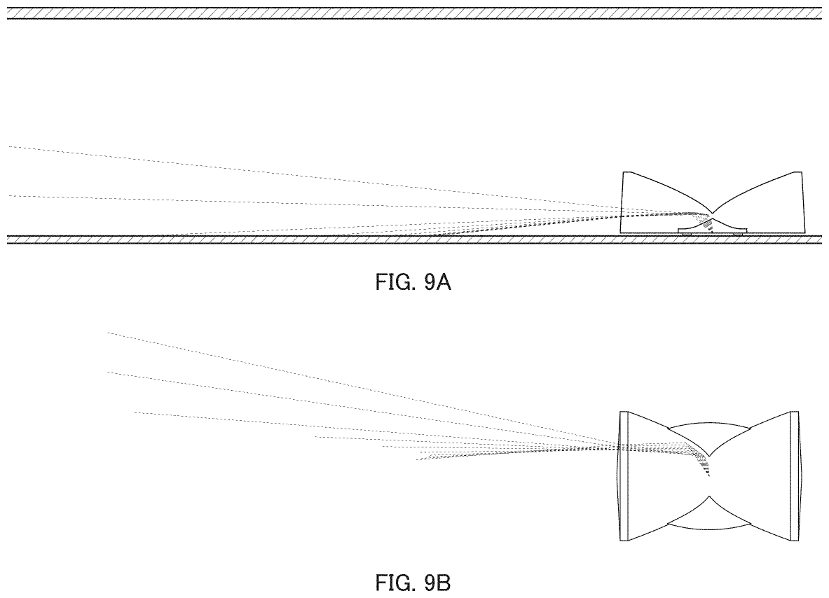

FIGS. 9A and 9B illustrate analysis results of light paths of light beams entered from the inner top surface of light flux controlling member 20 (light beams emitted at an angle of 0 to 30° with respect to light axis LA in front view, and at an angle of 50° with respect to light axis LA in side view) in the comparative surface light source device provided with light flux controlling member 20 illustrated in FIG. 7. FIG. 9A is a front view and FIG. 9B is a plan view.

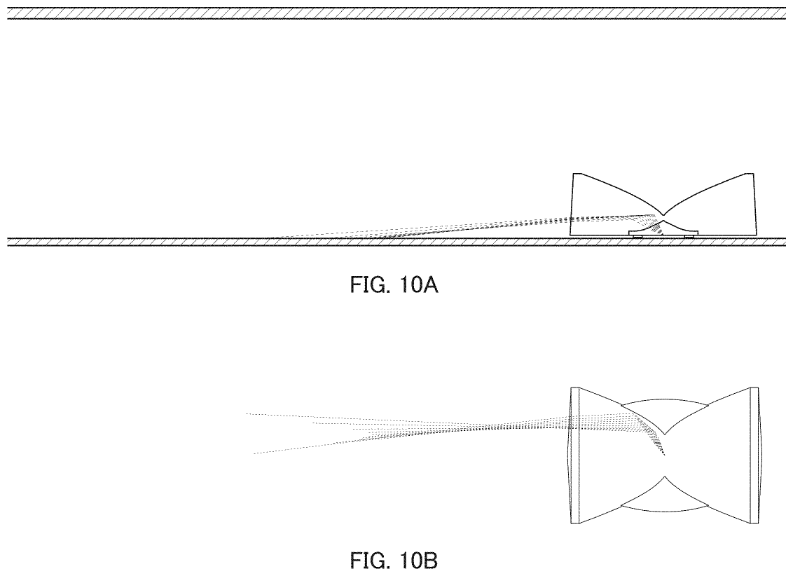

FIGS. 10A and 10B illustrate analysis results of light paths of light beams entered from the inner top surface of light flux controlling member 20 (light beams emitted at an angle of 30 to 60° with respect to light axis LA in front view, and at an angle of 50° with respect to light axis LA in side view) in the comparative surface light source device provided with light flux controlling member 20 illustrated in FIG. 7. FIG. 10A is a front view and FIG. 10B is a plan view.

FIG. 11 illustrates analysis results of light paths of light beams entered from inner side surface 133b of light flux controlling member 100 (light beams emitted at an angle of 86 to 90° with respect to light axis LA in front view) in surface light source device 100 provided with the light flux controlling member according to Embodiment 1.

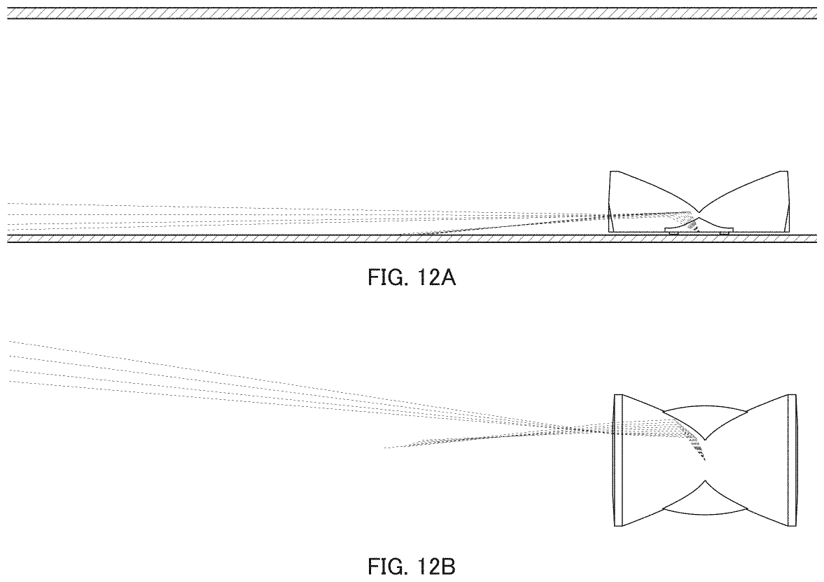

FIGS. 12A and 12B illustrate analysis results of light paths of light beams entered from inner top surface 133a of light flux controlling member 100 (light beams emitted at an angle of 0 to 30° with respect to light axis LA in front view, and at an angle of 50° with respect to light axis LA in side view) in surface light source device 100 provided with the light flux controlling member according to Embodiment 1. FIG. 12A is a front view and FIG. 12B is a plan view.

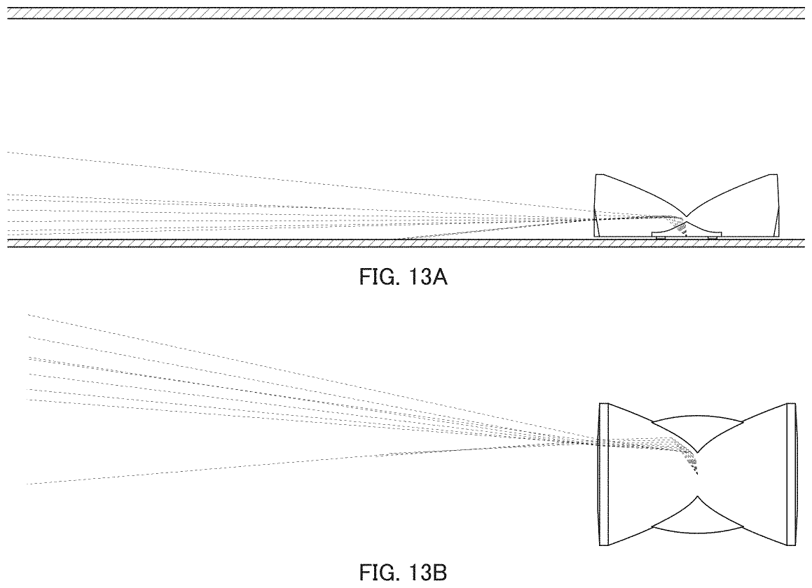

FIGS. 13A and 13B illustrate analysis results of light paths of light beams entered from inner top surface 133a of light flux controlling member 100 (light beams emitted at an angle of 30 to 60° with respect to light axis LA in front view, and at an angle of 50° with respect to light axis LA in side view) in surface light source device 100 provided with the light flux controlling member according to Embodiment 1. FIG. 13A is a front view and FIG. 13B is a plan view.

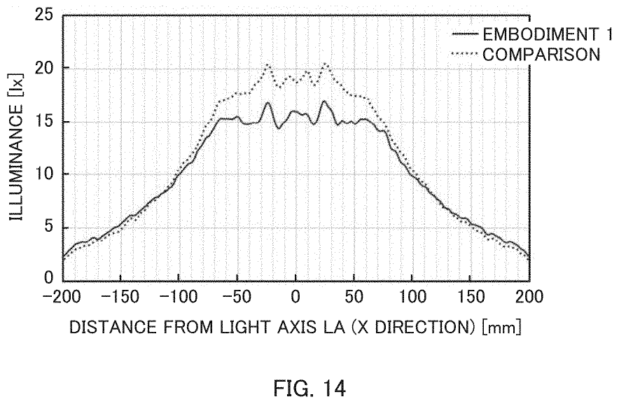

FIG. 14 illustrates analysis results of the illuminance distribution on light diffusion plate 150 in surface light source device 100 provided with the light flux controlling member according to Embodiment 1, and a surface light source device provided with the comparative light flux controlling member.

In FIG. 14, the abscissa indicates the distance from light axis LA of light emitting element 131 at light diffusion plate 150 (the distance in X-axis direction; mm), and the ordinate indicates the illuminance at light diffusion plate 150. The lateral axis direction in FIGS. 8 to 13B corresponds to the lateral axis direction in FIG. 14.

As illustrated in FIGS. 8 to 10B, in the surface light source device provided with comparative light flux controlling member 20, the majority of the light emitted from a region where the light entered from the inner side surface directly reaches emission surface 22 of light flux controlling member 20 advances downward. This light is reflected by the surface of the reflection sheet in the case where a reflection sheet is disposed around substrate 120, whereas the light is reflected by the surface of substrate 120 in a region around emission surface 22 in the case where substrate 120 has a large planar dimension. As a result, as illustrated in FIG. 14, the region around light emitting device 130 (region separated from light axis LA by −70 mm to 70 mm) becomes excessively bright, thus causing luminance unevenness.

In contrast, as illustrated in FIGS. 11 to 13, in surface light source device 100 provided with light flux controlling member 132 according to Embodiment 1, the majority of the light emitted from first inclined surface 140 of light flux controlling member 132 advances upward in comparison with the comparative light flux controlling member. As a result, as illustrated in FIG. 14, the region around light emitting device 130 (region separated from light axis LA by −70 mm to 70 mm) does not become excessively bright, and thus luminance unevenness can be suppressed.

### Effect

As described above, the light flux controlling member according to Embodiment 1 includes first inclined surface 140 at a region where light entered from inner side surface 133b of two emission surfaces 135 directly reaches. With this configuration, the majority of the light emitted from first inclined surface 140 is refracted upward, and thus downward light can be reduced. As a result, the region around light emitting device 130 does not become excessively bright, and light can be readily delivered to a remote location, and thus, luminance unevenness can be reduced.

### Embodiment 2

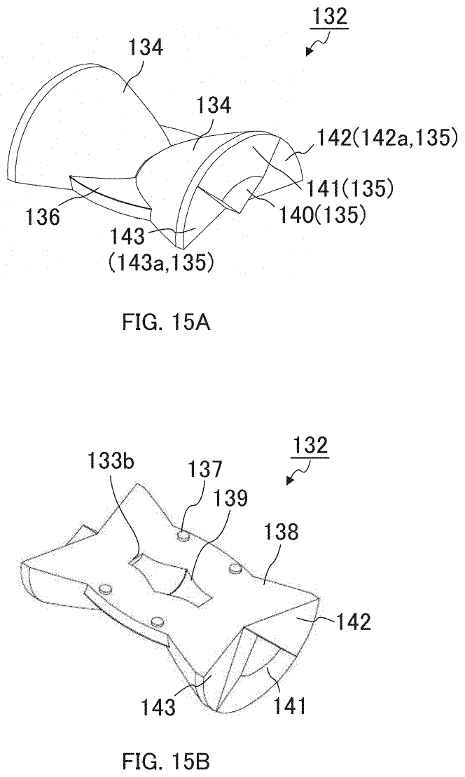

Next, with reference to FIGS. 15 to 17, light flux controlling member 132 according to Embodiment 2 is described. Light flux controlling member 132 according to Embodiment 2 is different from light flux controlling member 132 according to Embodiment 1 in that each of two emission surfaces 135 further includes a second emission surface and a third emission surface. Therefore, the same components as those of light flux controlling member 132 are denoted with the same reference numerals, and the description thereof is omitted.

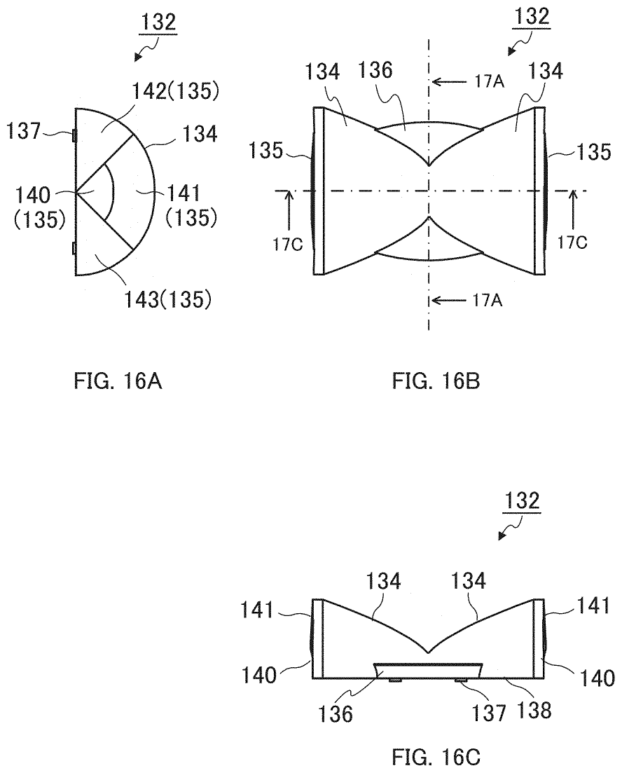

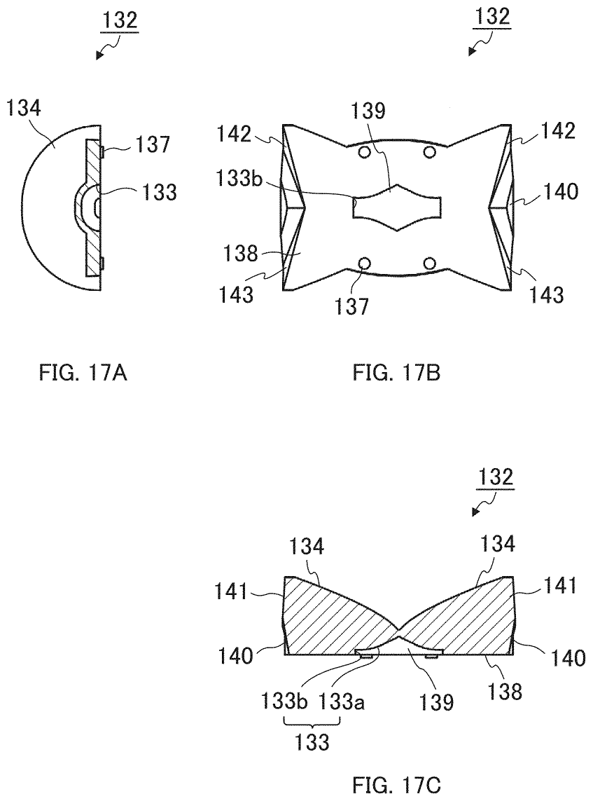

FIGS. 15 to 17 illustrate a configuration of light flux controlling member 132 according to Embodiment 2. FIG. 15A is a top perspective view light flux controlling member 132, and FIG. 15B is bottom perspective view of light flux controlling member 132. FIG. 16A is a side view of light flux controlling member 132, FIG. 16B is a plan view of light flux controlling member 132, and FIG. 16C is a front view of light flux controlling member 132. FIG. 17A is a sectional view taken along line 17A-17A of FIG. 16B, FIG. 17B is a bottom view, and FIG. 17C is a sectional view taken along line 17C-17C of FIG. 16B. In Embodiment 2, light flux controlling member 132 is plane symmetrical with respect to second virtual plane P2 (YZ plane).

In light flux controlling member 132 according to Embodiment 2, each of two emission surfaces 135 includes first inclined surface 140, first emission surface 141, second emission surface 142, and third emission surface 143 (see FIGS. 15A and 16A).

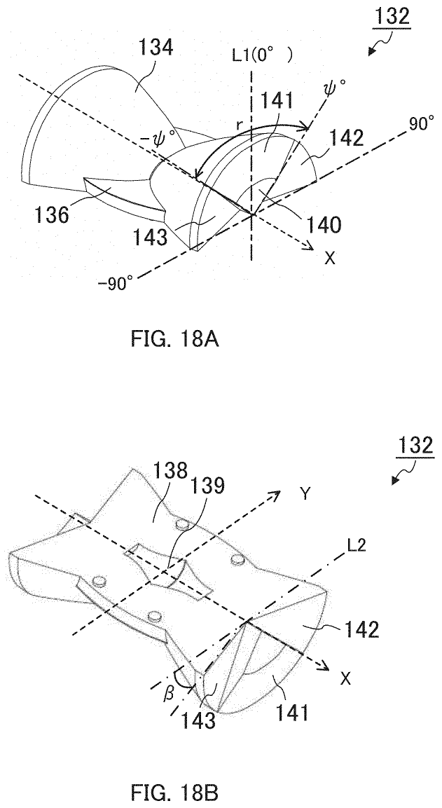

FIGS. 18A and 18B are perspective views for describing configurations of first emission surface 141, second emission surface 142 and third emission surface 143.

As illustrated in FIG. 18A, first emission surface 141 is an emission surface disposed outside first inclined surface 140 in a range of −ψ° to ψ° with respect to first virtual line L1 about the X axis at the center as viewed in a direction of the X axis. First virtual line L1 intersects the X axis and is parallel to light axis LA. Note that 0<ψ<90, preferably 15≤ψ≤90, and more preferably 15≤ψ≤60.

Opening angle r of first emission surface 141 meets r≤2ψ°. Preferably, opening angle r of first emission surface 141 is 30° to 120°, more preferably 30° to 90°. When opening angle r of first emission surface 141 is 30° or greater, the quantity of light travelling directly upward is not excessively increased, and accordingly light can be readily expanded in the X-axis direction, whereas when opening angle r of first emission surface 141 is 120° or smaller, light can be readily expanded in the Y-axis direction.

First emission surface 141 is a vertical surface that is substantially parallel to light axis LA. The “substantially parallel” means that the angle to light axis LA is ±3° or smaller. That is, first emission surface 141 corresponds to vertical surface 141 of light flux controlling member 132 according to Embodiment 1.

Second emission surface 142 is an emission surface provided within a range of ψ° to 90° with respect to first virtual line L1, and includes second inclined surface 142a inclined toward light axis LA in the direction toward the X axis. Third emission surface 143 is an emission surface provided within a range of −90° to −ψ° with respect to first virtual line L1, and includes third inclined surface 143a inclined toward light axis LA in the direction toward the X axis.

A part of second emission surface 142 and third emission surface 143 may be second inclined surface 142a or third inclined surface 143a, or the entirety of second emission surface 142 and third emission surface 143 may be second inclined surface 142a or third inclined surface 143a. In Embodiment 2, the entirety of second emission surface 142 and third emission surface 143 is second inclined surface 142a or third inclined surface 143a.

The inclination of second inclined surface 142a or third inclined surface 143a with respect to second virtual line L2 is greater than the inclination of first inclined surface 140 with respect to second virtual line L2 (see FIG. 18B). With such a configuration, light reaching second inclined surface 142a or third inclined surface 143a can be emitted while appropriately expanding the light in the Y-axis direction. Preferably, inclination angle β of second inclined surface 142a or third inclined surface 143a with respect to second virtual line L2 is 5° to 30°, more preferably 15° to 20°. Light can be readily expanded in the Y-axis direction when inclination angle β of second inclined surface 142a or third inclined surface 143a with respect to second virtual line L2 is 5° or greater, whereas the quantity of the light that is expanded in the X-axis direction is not excessively reduced when the angle is 30° or smaller. Inclination angle β of second inclined surface 142a and inclination angle β of third inclined surface 143a may be identical to each other or different from each other. The illuminance distribution and/or the range of the irradiation region is adjusted in accordance with the thickness, the size, the distance (pitch) between light emitting devices 130 of surface light source device 100, and therefore inclination angle β is also appropriately adjusted in accordance with the above-mentioned values.

As with first inclined surface 140, second inclined surface 142a and third inclined surface 143a may be an inclined surface linearly inclined toward light axis LA in the direction toward the X axis, or a curved inclined surface inclined toward light axis LA in the direction toward the X axis. In the case where second inclined surface 142a and third inclined surface 143a are curved inclined surfaces inclined toward light axis LA in the direction toward the X axis, the inclination angle, with respect to second virtual line L2, of the straight line connecting between the outer periphery of second inclined surface 142a or third inclined surface 143a and the intersection of second inclined surface 142a or third inclined surface 143a with the X axis is set to inclination angle β of second inclined surface 142a or third inclined surface 143a with respect to second virtual line L2.

Operations of light flux controlling member 132 according to Embodiment 2 are described below in comparison with light flux controlling member 132 according to Embodiment 1.

In light flux controlling member 132 according to Embodiment 1, light emitted from light emitting element 131 is entered from incidence surface 133. The light entered from inner top surface 133a of incidence surface 133 is reflected by two reflection surfaces 134 so as to advance in two directions that are substantially opposite to each other and are substantially perpendicular to light axis LA of light emitting element 131, and to reach two emission surfaces 135. The light entered from inner side surface 133b of incidence surface 133 directly reaches two emission surfaces 135. The light having reached two emission surfaces 135 is emitted from two emission surfaces 135.

Here, two emission surfaces 135 do not include second inclined surface 142a (second emission surface 142) and third inclined surface 143a (third emission surface 143). Accordingly, the light emitted from two emission surfaces 135 (i.e., light included in a range of −90° to −ψ° with respect to first virtual line L1 and light included in a range of ψ° to 90° with respect to first virtual line L1) readily expands in the X-axis direction, but does not readily expand in the Y-axis direction (see FIG. 12B). As a result, light may not sufficiently reach the four corners of the surface light source device.

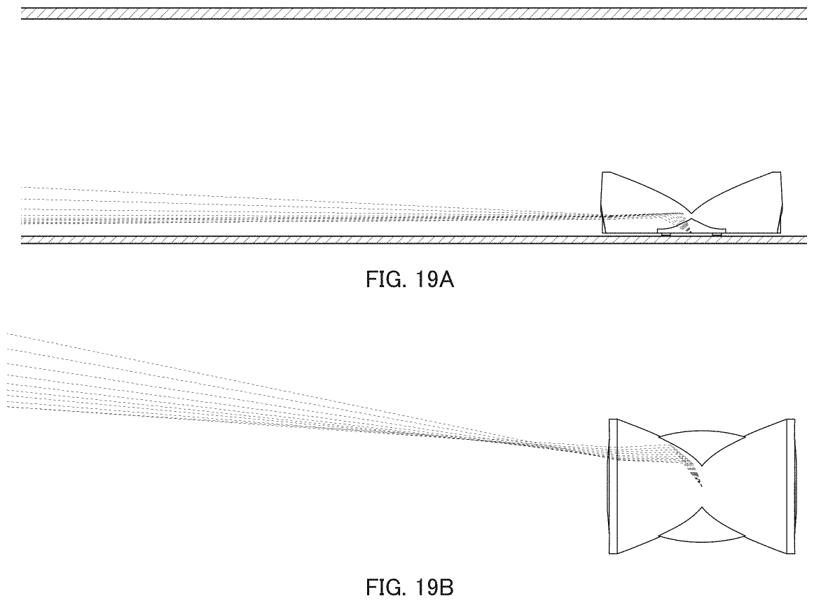

In contrast, in light flux controlling member 132 according to Embodiment 2, two emission surfaces 135 further includes second inclined surface 142a (second emission surface 142) and third inclined surface 143a (third emission surface 143). As a result, the light emitted from second inclined surface 142a of two emission surfaces 135 (light included in a range of ψ° to 90° with respect to first virtual line L1) and light emitted from third inclined surface 143a of two emission surfaces 135 (light included in a range of −90° to −ψ° with respect to first virtual line L1) readily appropriately expands also in the Y-axis direction while appropriately expanding in the X-axis direction (see FIG. 19B). As a result, sufficient light readily reaches the four corners of the surface light source device, and it is thus possible to suppress reduction in luminance at the four corner portions relative to the center portion in surface light source device 100.

### Simulation 2-1

In Simulation 2-1, light paths were analyzed with surface light source device 100 provided with a light flux controlling member according to Embodiment 2 (light flux controlling member 132 illustrated in FIGS. 15 to 17). The analysis of the light paths were conducted with surface light source device 100 provided with only one light emitting device 130.

The parameters of the light flux controlling member were set as in Simulation 1 except that the parameters of emission surface 135 were set as follows.

### Parameters

Opening angle r of first emission surface 141: 90° (−45° to 45° with respect to first virtual line L1)

Inclination angle α of first inclined surface 140 with respect to second virtual line L2: 10°

Inclination angle β of second inclined surface 142a and third inclined surface 143a with respect to second virtual line L2: 15°

FIGS. 19A and 19B illustrate analysis results of light paths of light beams entered from inner top surface 133a of light flux controlling member 132 (light beams emitted at an angle of 0 to 30° with respect to light axis LA in front view, and at an angle of 50° with respect to light axis LA in side view) in the surface light source device 100 provided with the light flux controlling member according to Embodiment 2. FIG. 19A is a front view and FIG. 19B is a plan view.

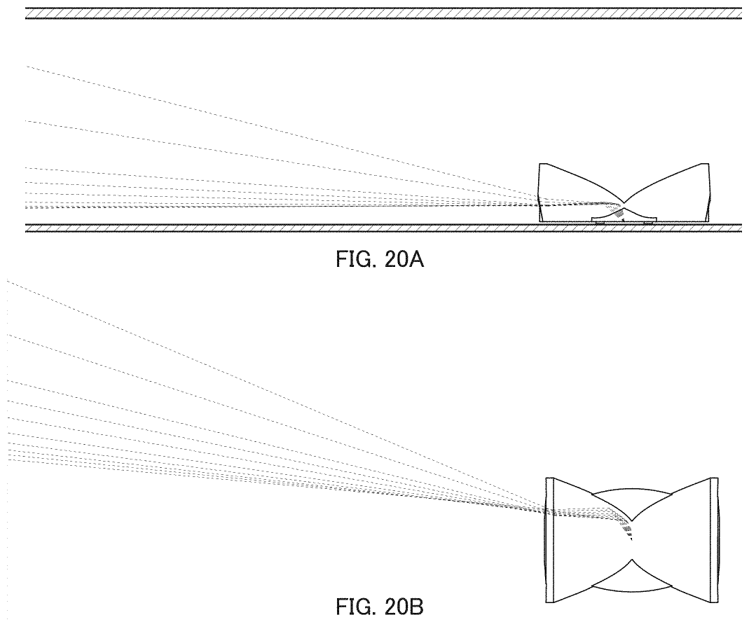

FIGS. 20A and 20B illustrate analysis results of light paths of light beams entered from inner top surface 133a of light flux controlling member 132 (light beams emitted at an angle of 30 to 60° with respect to light axis LA in front view, and at an angle of 50° with respect to light axis LA in side view) in the surface light source device 100 provided with the light flux controlling member according to Embodiment 2. FIG. 20A is a front view and FIG. 20B is a plan view.

As seen in FIGS. 12B and 13B, in surface light source device 100 provided with light flux controlling member 132 according to Embodiment 1, the majority of the light emitted from two emission surfaces 135 readily expands in the X axis, but does not readily expand in the Y-axis direction.

In contrast, as seen in FIGS. 19B and 20B, in surface light source device 100 provided with light flux controlling member 132 according to Embodiment 2, the majority of the light emitted from two emission surfaces 135 readily appropriately expands also in the Y axis while expanding in the X-axis direction.

### Simulation 2-2

In Simulation 2-2, the illuminance distribution on light diffusion plate 150 were analyzed with surface light source devices 100 provided with light flux controlling members A-1 to D-4 in which opening angle r of first emission surface 141 and inclination angle β of second emission surface 142 and third emission surface 143 are set as follows in the light flux controlling member according to Embodiment 2 (light flux controlling member 132 illustrated in FIGS. 15 to 17). The illuminance distribution on light diffusion plate 150 was analyzed with surface light source device 100 provided with only one light emitting device 130.

Parameters of the light flux controlling member were set as in Simulation 1 except that the parameters of emission surface 135 were set as follows.

### Parameters

### Light Flux Controlling Members A-1 to A-4

Opening angle r of first emission surface 141: 30° (−15° to 15° with respect to first virtual line L1)

Inclination angle β of second inclined surface 142a and third inclined surface 143a with respect to second virtual line L2: 5° (A-1), 10° (A-2), 15° (A-3), 20° (A-4)

Inclination angle α of first inclined surface 140 with respect to second virtual line L2: 10°

### Light Flux Controlling Members B-1 to B-4

Opening angle r of first emission surface 141: 60° (−30° to 30° with respect to first virtual line L1)

Inclination angle β of second inclined surface 142a and third inclined surface 143a with respect to second virtual line L2: 5° (B-1), 10° (B-2), 15° (B-3), 20° (B-4)

Inclination angle α of first inclined surface 140 with respect to second virtual line L2: 10°

### Light Flux Controlling Members C-1 to C-4

Opening angle r of first emission surface 141: 90° (−45° to 45° with respect to first virtual line L1)

Inclination angle β of second inclined surface 142a and third inclined surface 143a with respect to second virtual line L2: 5° (C-1), 10° (C-2), 15° (C-3), 20° (C-4)

Inclination angle α of first inclined surface 140 with respect to second virtual line L2: 10°

### Light Flux Controlling Members D-1 to D-4

Opening angle r of first emission surface 141: 120° (−60° to 60° with respect to first virtual line L1)

Inclination angle β of second inclined surface 142a and third inclined surface 143a with respect to second virtual line L2: 5° (D-1), 10° (D-2), 15° (D-3), 20° (D-4)

Inclination angle α of first inclined surface 140 with respect to second virtual line L2: 10°

In addition, for comparison, the distribution illuminance on light diffusion plate 150 was analyzed also with surface light source device 100 provided with the light flux controlling member according to Embodiment 1 (light flux controlling member R-1) used in Simulation 1.

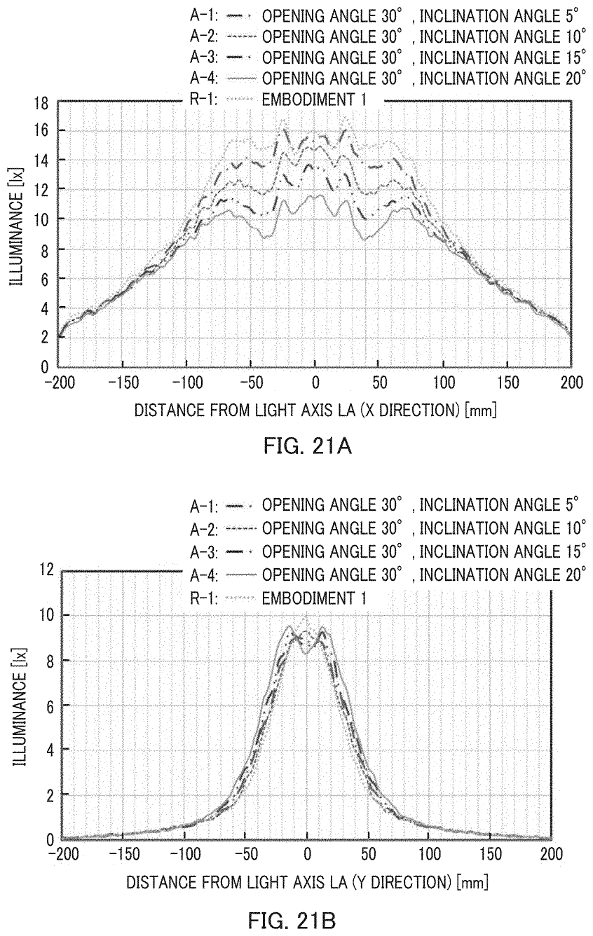

FIGS. 21A and 21B are graphs illustrating analysis results of the illuminance distribution on light diffusion plate 150 in surface light source device 100 provided with light flux controlling members A-1 to A-4 according to Embodiment 2. FIG. 21A illustrates illuminance distributions in the X-axis direction at Y=0 mm, and FIG. 21B illustrates illuminance distributions in the Y-axis direction at X=100 mm.

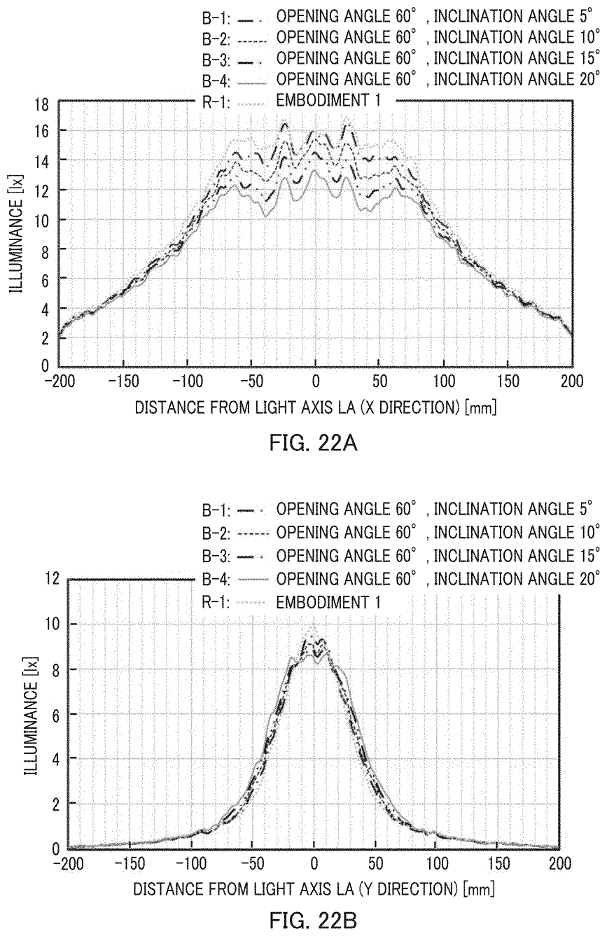

FIGS. 22A and 22B are graphs illustrating analysis results of the illuminance distribution on light diffusion plate 150 in surface light source device 100 provided with light flux controlling members B-1 to B-4 according to Embodiment 2. FIG. 22A illustrates illuminance distributions in the X-axis direction at Y=0 mm, and FIG. 22B illustrates illuminance distributions in the Y-axis direction at X=100 mm.

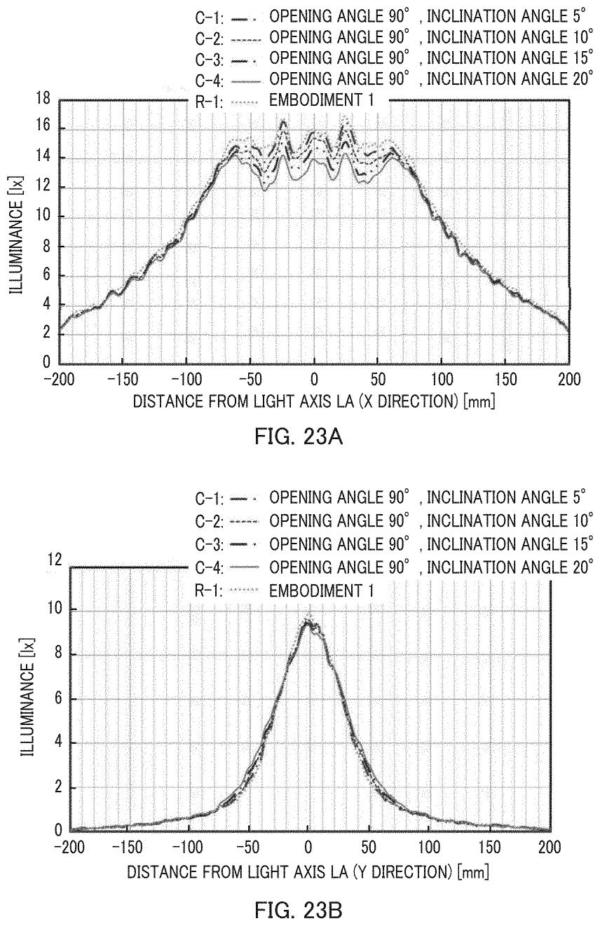

FIGS. 23A and 23B are graphs illustrating analysis results of the illuminance distribution on light diffusion plate 150 in surface light source device 100 provided with light flux controlling members C-1 to C-4 according to Embodiment 2.

FIG. 23A illustrates illuminance distributions in the X-axis direction at Y=0 mm, and FIG. 23B illustrates illuminance distributions in the Y-axis direction at X=100 mm.

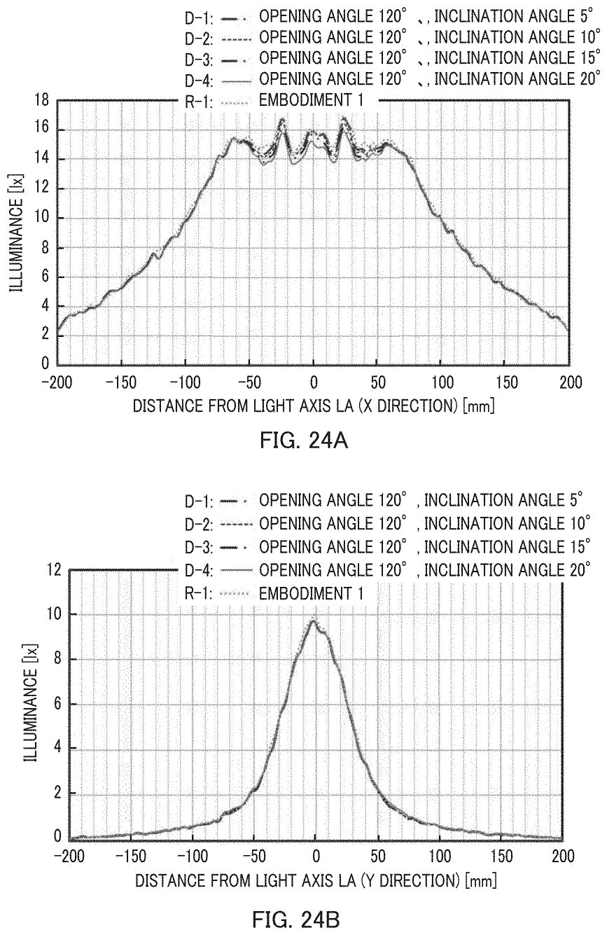

FIGS. 24A and 24B are graphs illustrating analysis results of the illuminance distribution on light diffusion plate 150 in surface light source device 100 provided with light flux controlling members D-1 to D-4 according to Embodiment 2. FIG. 24A illustrates illuminance distributions in the X-axis direction at Y=0 mm, and FIG. 24B illustrates illuminance distributions in the Y-axis direction at X=100 mm.

In FIGS. 21A, 22A, 23A and 24A, the abscissa indicates the distance (mm) from light axis LA in the X-axis direction at Y=0 mm, and the ordinate indicates the illuminance at light diffusion plate 150. In FIGS. 21B, 22B, 23B and 24B, the abscissa indicates the distance (mm) from light axis LA in the Y-axis direction at X=100 mm, and the ordinate indicates the illuminance at light diffusion plate 150.

As illustrated in FIGS. 21A, 22A, 23A and 24A, in surface light source device 100 provided with light flux controlling member 132 according to Embodiment 2, the smaller the opening angle r, or the greater the inclination angle β of second inclined surface 142a and third inclined surface 143a, excessive brightness in a region around light emitting device 130 (a region separated from light axis LA by −70 mm to 70 mm) can be further suppressed, and light emitted from second inclined surface 142a and third inclined surface 143a can be more readily emitted in the direction away from the X axis, thereby more readily delivering the light to a remote location.

As illustrated in FIGS. 21B, 22B, 23B and 24B, in surface light source device 100 provided with light flux controlling member 132 according to Embodiment 2, the smaller opening angle r, or greater inclination angle β of second inclined surface 142a and third inclined surface 143a, light emitted from emission surface 135 readily appropriately expand also in the Y-axis direction, while expanding in the X-axis direction. In addition, the greater the opening angle r, the less the change in light expansion in accordance with the change in inclination angle β. In view of the foregoing, it is preferable that opening angle r be 30 to 90°, and inclination angle β of second inclined surface 142a and third inclined surface 143a be 10 to 20° in order to control the light such that light emitted from emission surface 135 readily appropriately expands not only in the X axis, but also in the Y-axis direction. As a result, light can sufficiently reach the four corners of surface light source device 100, and the luminance of the four corners of surface light source device 100 can be prevented from becoming excessively lower than the luminance of the center portion.

### Effect

As described above, in the light flux controlling member according to Embodiment 2, each of two emission surfaces 135 includes not only first inclined surface 140, but also second inclined surface 142a (second emission surface 142) and third inclined surface 143a (third emission surface 143). With this configuration, at least a certain quantity of the light emitted from two emission surfaces 135 can be readily appropriately expanded not only in the X-axis direction, but also in the Y-axis direction while achieving the above-described effect (the effect of suppressing luminance unevenness by suppressing excessive brightness in a region around light emitting device 130 and readily delivering light to a remote location). Thus, sufficient light can be readily delivered to the four corners of surface light source device 100, and the luminance at the four corner portions can be prevented from becoming lower than the luminance of the center portion in the surface light source device 100.

### Embodiment 3

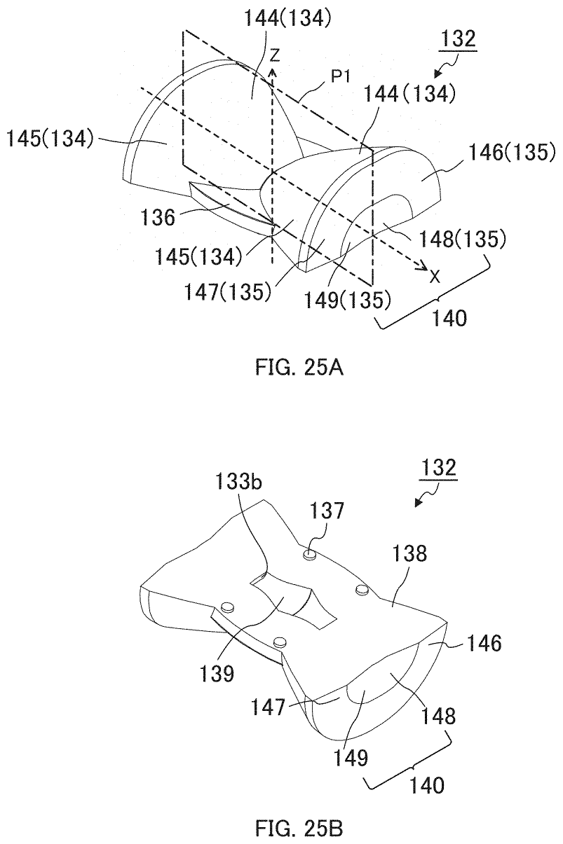

Next, with reference to FIGS. 25 to 27, light flux controlling member 132 according to Embodiment 3 is described. Light flux controlling member 132 according to Embodiment 3 is different from light flux controlling member 132 according to Embodiment 1 in that each of two reflection surfaces 134 includes a first reflection surface and a second reflection surface, and, that each of two emission surfaces 135 includes a fourth emission surface and a fifth emission surface. Therefore, the same components as those of light flux controlling member 132 are denoted with the same reference numerals, and the description thereof is omitted.

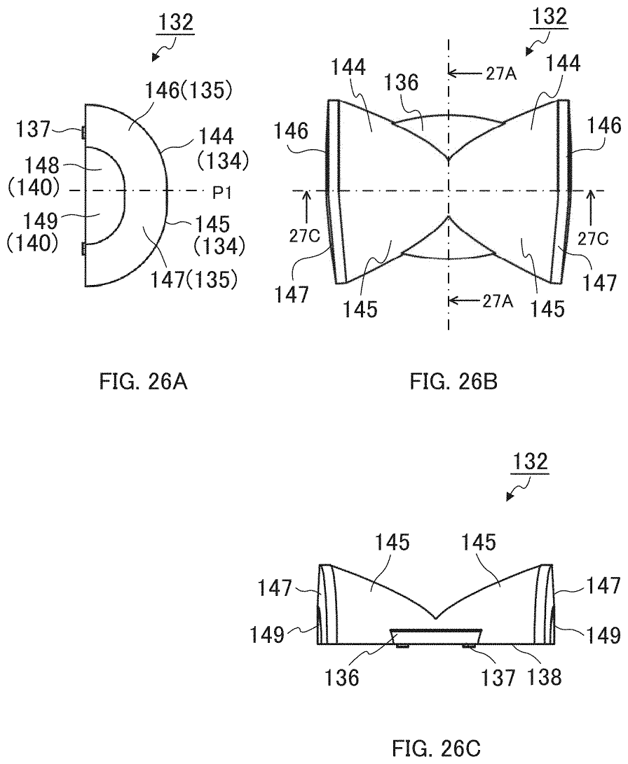

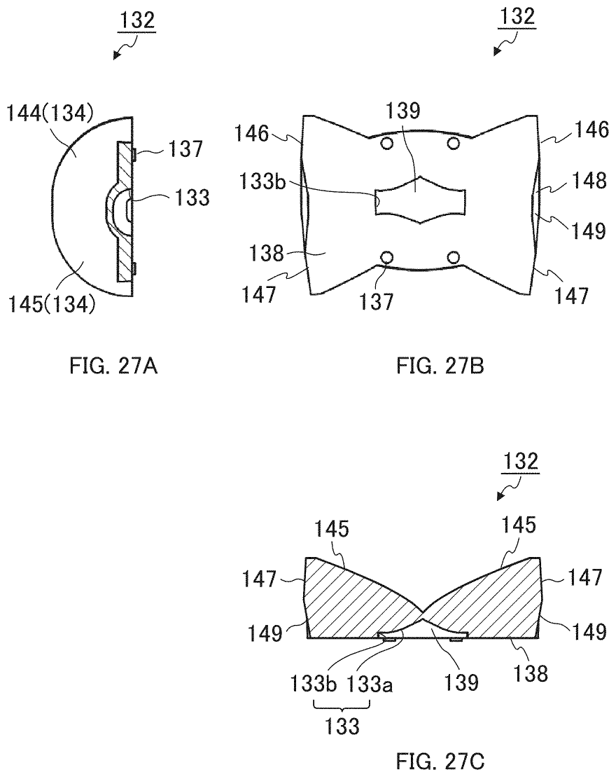

FIGS. 25A to 27C illustrate a configuration of light flux controlling member 132 according to Embodiment 3. FIG. 25A is a top perspective view of light flux controlling member 132, and FIG. 25B is a bottom perspective view of light flux controlling member 132. FIG. 26A is a side view of light flux controlling member 132, FIG. 26B is a plan view of light flux controlling member 132, and FIG. 26C is a front view of light flux controlling member 132. FIG. 27A is a sectional view taken along line 27A-27A of FIG. 26B, FIG. 27B is a bottom view, and FIG. 27C is a sectional view taken along line 27C-27C of FIG. 26B. In Embodiment 3, light flux controlling member 132 is plane symmetrical with respect to second virtual plane P2 (YZ plane).

In light flux controlling member 132 according to Embodiment 3, each of two reflection surfaces 134 includes first reflection surface 144 and second reflection surface 145.

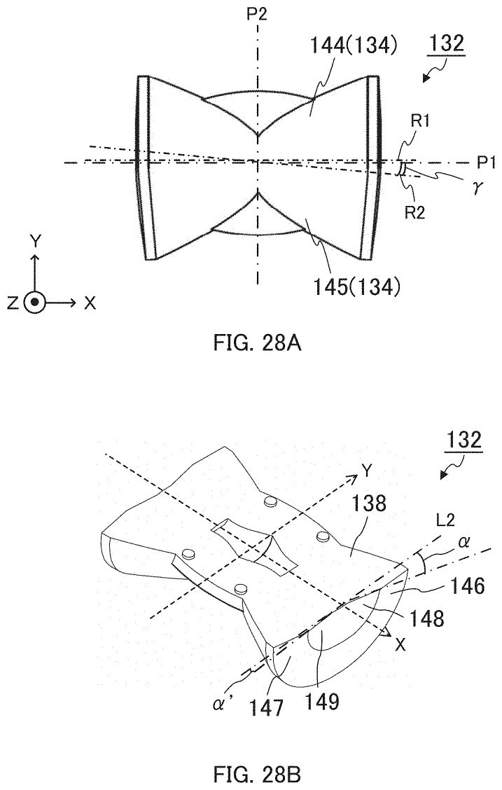

FIGS. 28A and 28B are diagrams for describing configurations of first reflection surface 144 and second reflection surface 145.

As illustrated in FIG. 28A, first reflection surface 144 is a reflection surface that is disposed on one side with respect to first virtual plane P1 (XZ plane), and can include a part of a rotationally symmetrical surface whose rotation center is first rotation axis R1. Second reflection surface 145 is disposed on the other side with respect to first virtual plane P1 (XZ plane), and can include a part of a rotationally symmetrical surface whose rotation center is second rotation axis R2.

When a cross section including the X axis and inclined at an arbitrary inclination angle with respect to light axis LA on one side of first virtual plane P1 (XZ plane) is set as cross section C4, and a cross section including the X axis and inclined at an arbitrary inclination angle with respect to light axis LA on the other side with respect to first virtual plane P1 (XZ plane) is set as cross section C5, the average value of the inclination of second reflection surface 145 with respect to the X axis in the cross section C5 is greater than the average value of the inclination of first reflection surface 144 with respect to the X axis in axis cross section C4.

The average value of the inclination of second reflection surface 145 with respect to the X axis can be determined in cross section C5 by providing tangents to second reflection surface 145 at a constant interval in the X-axis direction from light axis LA side, and by obtaining the average value of the inclinations thereof. Likewise, the average value of the inclination of first reflection surface 144 with respect to the X axis can be determined as above.

Preferably, in third virtual plane P3 (XY plane), first rotation axis R1 in first reflection surface 144 is parallel to the X axis, and second rotation axis R2 in second reflection surface 145 is inclined such that second rotation axis R2 is separated away from the X axis in the direction away from light axis LA. When second rotation axis R2 is inclined such that the axis is separated away from the X axis in the direction away from light axis LA, light reflected by second reflection surface 145 and emitted from fifth emission surface 147 can be readily expanded in the Y-axis direction. In light flux controlling member 132 according to Embodiment 3, in any cross section parallel to third virtual plane P3 (XY plane), the distances of first reflection surface 144 and second reflection surface 145 from first virtual plane P1 (XZ plane) increase in the direction away from second virtual plane P2 (YZ plane), and the degree of the increase is more significant in second reflection surface 145, and thus, light reflected by second reflection surface 145 can be more readily expanded in the Y-axis direction. Preferably, in the case where a plurality of light emitting devices 130 are disposed in a line at 30 mm-pitch along the short side direction of 32-inch surface light source device 100, inclination angle γ of second rotation axis R2 with respect to the X axis is 2° to 10°, or more preferably 4° to 8° although it depends on the size of surface light source device 100 and/or the pitch of the plurality of light emitting devices 130 (see FIG. 28A).

In addition, in light flux controlling member 132 according to Embodiment 3, each of two emission surfaces 135 includes first inclined surface 140, fourth emission surface 146, and fifth emission surface 147.

First inclined surface 140 includes fourth inclined surface 148 disposed on one side with respect to first virtual plane P1 (XZ plane), and fifth inclined surface 149 disposed on the other side with respect to first virtual plane P1 (XZ plane). Inclination angle α′ of fifth inclined surface 149 with respect to second virtual line L2 is a value obtained by subtracting inclination angle γ of second rotation axis R2 from inclination angle α of fourth inclined surface 148 with respect to second virtual line L2 (see FIGS. 28A and 28B).

Fourth emission surface 146 is an emission surface disposed outside fourth inclined surface 148 on one side with respect to first virtual plane P1 (XZ plane), as viewed in a direction of the X axis. Fourth emission surface 146 is substantially parallel to second virtual plane P2 (YZ plane). The state of substantially parallel to second virtual plane P2 (YZ plane) means that the inclination angle with respect to second virtual plane P2 (YZ plane) is ±3° or smaller.

Fifth emission surface 147 is an emission surface disposed outside fifth inclined surface 149 on the other side with respect to first virtual plane P1, as viewed in a direction of the X axis. Fifth emission surface 147 is inclined toward second virtual plane P2 (YZ plane) in the direction away from the X axis. The inclination angle of fifth emission surface 147 with respect to second virtual plane P2 (YZ plane) is identical to inclination angle γ of second rotation axis R2 with respect to the X axis.

Preferably, light flux controlling member 132 according to Embodiment 3 is used as light emitting devices 130 disposed at both ends in light emitting devices 130 disposed in a line illustrated in FIG. 3A. In such a configuration, each light flux controlling member 132 is disposed such that second reflection surface 145 is opposite to a closer inner wall surface of housing 110.

Now operations of light flux controlling member 132 according to Embodiment 3 are described in comparison with light flux controlling member 132 according to Embodiment 1.

In light flux controlling member 132 according to Embodiment 1, the light entered from inner top surface 133a is reflected by two reflection surfaces 134 so as to travel in two directions that are substantially opposite to each other and are substantially perpendicular to light axis LA of light emitting element 131, and to reach two emission surfaces 135. On the other hand, the light entered from inner side surface 133b of incidence surface 133 directly reaches two emission surfaces 135. The light having reached two emission surfaces 135 is emitted from two emission surfaces 135.

At this time, each of two reflection surfaces 134 do not include second reflection surface 145, and each of two emission surfaces 135 does not include fifth emission surface 147. Accordingly, the majority of the light emitted from two emission surfaces 135 is readily expanded in the X-axis direction, but is not readily expanded in the Y-axis direction (see FIGS. 12B and 13B).

In contrast, in light flux controlling member 132 according to Embodiment 3, each of two reflection surfaces 134 includes second reflection surface 145 only on the other side with respect to first virtual plane P1 (XZ plane), and each of two emission surfaces 135 includes fifth emission surface 147 only on the other side with respect to first virtual plane P1 (XZ plane).

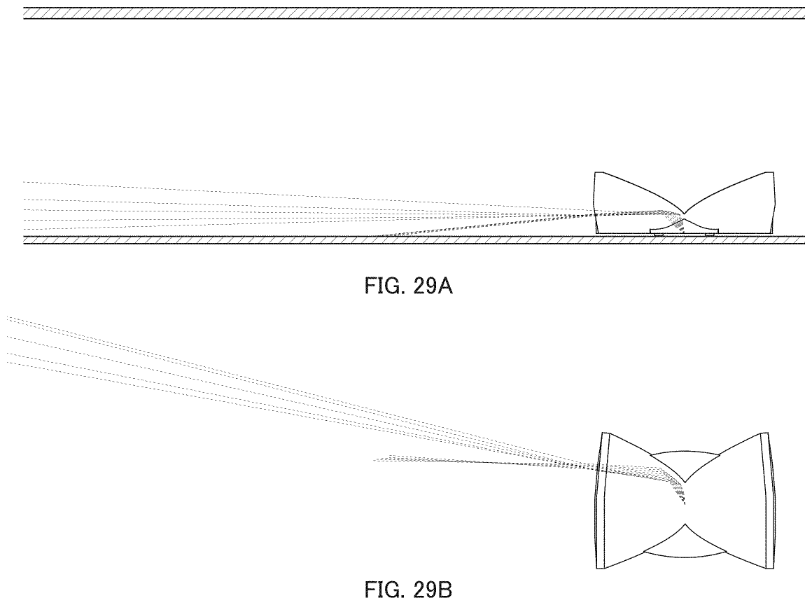

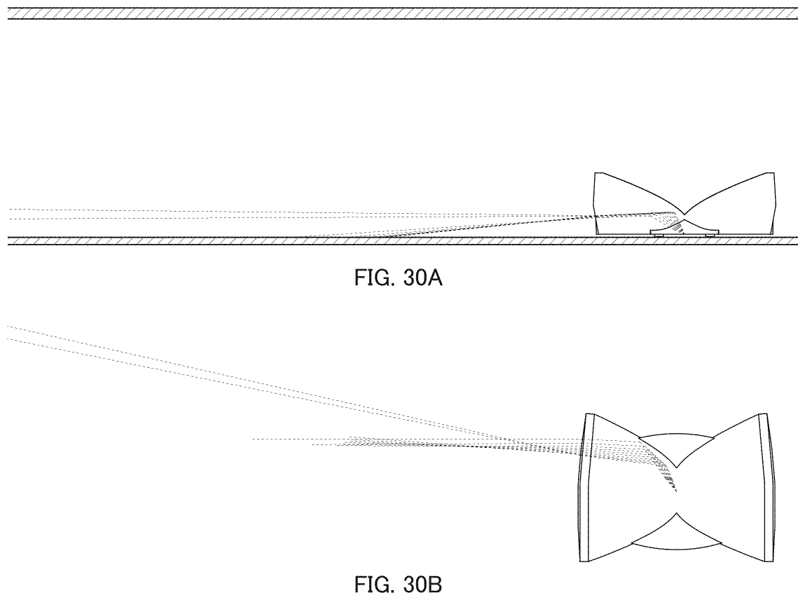

Thus, the light emitted from the other side with respect to first virtual plane P1 (XZ plane) in two emission surfaces 135 (light emitted from fifth emission surface 147) is readily appropriately expanded in the Y-axis direction than light emitted from one side with respect to first virtual plane P1 (XZ plane) (light emitted from fourth emission surface 146) (see FIGS. 29B and 30B). In other words, light can be asymmetrically expanded in the Y-axis direction.

By disposing such a light flux controlling member in at least light emitting devices 130 at both ends in the plurality of light emitting devices 130 disposed in a line in FIG. 3A such that second reflection surface 145 faces the inner wall surface of housing 110, light can be sufficiently delivered to the four corners of surface light source device 100. Thus, the luminance at the four corner portions can be prevented from becoming excessively lower than that of a center portion in surface light source device 100.

### Simulation 3

In Simulation 3, the light paths and the illuminance distribution on light diffusion plate 150 were analyzed with surface light source device 100 provided with the light flux controlling member according to Embodiment 3 (light flux controlling member 132 illustrated in FIGS. 25A to 27C). The light paths and the illuminance distribution on light diffusion plate 150 were analyzed with surface light source device 100 provided with only one light emitting device 130.

The parameters of the light flux controlling member were set as in Simulation 1 except that the parameters of reflection surface 134 and emission surface 135 were set as follows.

### Parameters

The inclination angle of first rotation axis R1 in first reflection surface 144 with respect to the X axis: 0°

Inclination angle γ of second rotation axis R2 in second reflection surface 145 with respect to the X axis: 5°

The inclination angle of fourth emission surface 146 with respect to second virtual plane P2 (YZ plane): 0°

The inclination angle of fifth emission surface 147 with respect to second virtual plane P2 (YZ plane): 5°

Inclination angle α of fourth inclined surface 148 with respect to second virtual line L2: 10°

Inclination angle α′ of fifth inclined surface 149 with respect to second virtual line L2: 10°

In addition, for comparison, the illuminance distribution on the light diffusion plate was analyzed with a surface light source device provided with light flux controlling member 132 according to Embodiment 1 (FIGS. 5A to 6C).

FIGS. 29A and 29B illustrate analysis results of light paths of light beams entered from inner top surface 133a of light flux controlling member 132 (light beams emitted at an angle of 0 to 30° with respect to light axis LA in front view, and at an angle of 50° with respect to light axis LA in side view) in surface light source device 100 provided with the light flux controlling member according to Embodiment 3. FIG. 29A is a front view and FIG. 29B is a plan view.

FIGS. 30A and 30B illustrate analysis results of light paths of light beams entered from inner top surface 133a of light flux controlling member 132 (light beams emitted at an angle of 30 to 60° with respect to light axis LA in front view, and at an angle of 50° with respect to light axis LA in side view) in surface light source device 100 provided with the light flux controlling member according to Embodiment 3. FIG. 30A is a front view and FIG. 30B is a plan view.

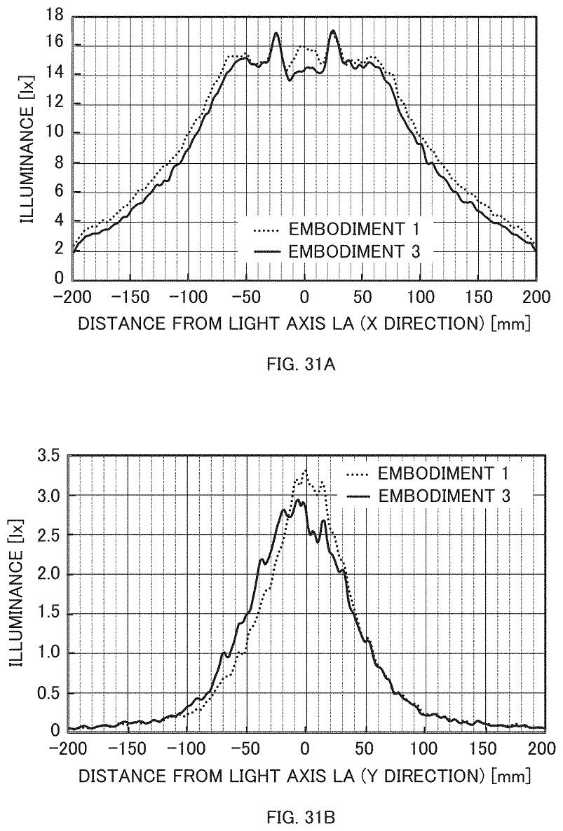

FIGS. 31A and 31B are graphs illustrating analysis results of the illuminance distribution on light diffusion plate 150 in surface light source device 100 provided with the light flux controlling member according to Embodiment 3. FIG. 31A illustrates illuminance distributions at Y=0 mm in the X-axis direction, and FIG. 31B illustrates illuminance distributions at X=190 mm in the Y-axis direction. The lateral axis direction in FIGS. 29A to 30B corresponds to the lateral axis direction in FIG. 31.

As illustrated in FIGS. 12B and 13B, in surface light source device 100 provided with light flux controlling member 132 according to Embodiment 1, the majority of the light emitted from two emission surfaces 135 is readily expanded in the X-axis direction, but is not readily expanded in the Y-axis.

In contrast, as illustrated in FIGS. 29B and 30B, in surface light source device 100 provided with light flux controlling member 132 according to Embodiment 3, the light emitted from the other side with respect to first virtual plane P1 (XZ plane) in two emission surfaces 135 (light emitted from fifth emission surface 147) is readily appropriately expanded in the Y-axis direction in comparison with light emitted from one side with respect to first virtual plane P1 (XZ plane) (light emitted from fourth emission surface 146).

As a result, the light flux controlling member according to Embodiment 3 can asymmetrically expand light to the negative side in the Y axis direction (the other side with respect to first virtual plane P1 (XZ plane)) (see FIG. 31B) in comparison with the light flux controlling member according to Embodiment 1 while expanding light in the X-axis direction (see FIG. 31A).

### Simulation 4

In Simulation 4, the luminance distribution was analyzed with surface light source device 100 provided with the light flux controlling member according to Embodiment 1 (light flux controlling member 132 illustrated in FIGS. 5A to 6C), surface light source device 100 provided with light flux controlling member C-3 according to Embodiment 2 (opening angle r=90°, inclination angle β=15°, light flux controlling member 132 illustrated in FIGS. 15A to 18C), and surface light source device 100 provided with the light flux controlling member according to Embodiment 3 (light flux controlling member 132 illustrated in FIGS. 25A to 27C). The luminance distribution was analyzed with surface light source device 100 provided with only one light emitting device 130.

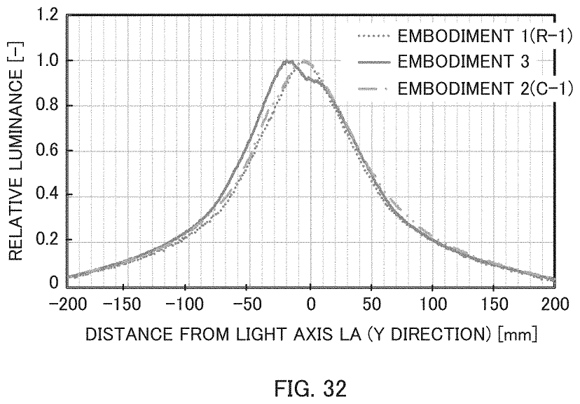

FIG. 32 illustrates analysis results of the relative luminance in which the maximum luminance of the luminance distributions at X=100 mm is set to 1 in surface light source device 100 provided with light flux controlling member 132 according to Embodiment 3, surface light source device 100 provided with light flux controlling member 132 according to Embodiment 1, and surface light source device 100 provided with light flux controlling member 132 according to Embodiment 2.

In FIG. 32, the abscissa indicates the distance from light axis LA (distance in the Y-axis direction; mm), and the ordinate indicates the relative luminance in which the maximum luminance in each luminance distribution at X=100 mm is set to 1.

As illustrated in FIG. 32, in surface light source device 100 provided with light flux controlling member 132 according to Embodiment 2, light is symmetrically expanded in the Y-axis direction in comparison with surface light source device 100 provided with light flux controlling member 132 according to Embodiment 1. In addition, in surface light source device 100 provided with light flux controlling member 132 according to Embodiment 3, light is asymmetrically expanded in the Y-axis direction in comparison with surface light source device 100 provided with light flux controlling member 132 according to Embodiment 1. Thus, sufficient light can be readily delivered to the four corners of surface light source device 100, and the luminance at the four corners can be prevented from becoming excessively lower than that of the center portion.

### Effect

As described above, in the light flux controlling member according to Embodiment 3, each of two emission surfaces 135 includes first inclined surface 140, and each of two reflection surfaces 134 includes second reflection surface 145 only on the other side with respect to first virtual plane P1 (XZ plane), and further, each of two emission surfaces 135 includes fifth emission surface 147 only on the other side with respect to first virtual plane P1 (XZ plane). Thus, while achieving the above-described effect (the effect of suppressing luminance unevenness by suppressing excessive brightness in a region around light emitting device 130 and readily delivering light to a remote location), light emitted from the other side with respect to first virtual plane P1 (XZ plane) (light emitted from fifth emission surface 147) can be appropriately expanded in the Y-axis direction (light can be asymmetrically expanded in the Y-axis direction) than light emitted from the one side with respect to first virtual plane P1 (XZ plane) (light emitted from fourth emission surface 146).

By disposing such a light flux controlling member in at least light emitting devices 130 at both ends in the plurality of light emitting devices 130 disposed in a line in FIG. 3A such that second reflection surface 145 faces the inner wall surface of housing 110, light can be sufficiently delivered to the four corners of surface light source device 100. Thus, the luminance at the four corner portions can be prevented from becoming excessively lower than that of a center portion in surface light source device 100.

While housing 110 includes bottom plate 111a and two inclined surfaces 111b sandwiching bottom plate 111a in Embodiments 1 to 3, the present invention is not limited to this, housing 110 may have a shape of a cuboid box composed of a bottom plate, a top plate opposite to the bottom plate, and four side plates connecting the bottom plate and the top plate. In this case, a reflection plate including an inclined surface may be disposed inside the cuboid box so that light emitted from light emitting element 131 can be readily collected at light diffusion plate 150.

While the plurality of light emitting devices 130 are disposed in a line in surface light source device 100 in Embodiments 1 to 3, the present invention is not limited to this, and the plurality of light emitting devices 130 may be disposed in two or more lines.

While the entirety of each of third emission surface 143 and second emission surface 142 is second inclined surface 142a and third inclined surface 143a in light flux controlling member 132 in Embodiment 2, the present invention is not limited to this, and second inclined surface 142a and third inclined surface 143a may be disposed only in a part of third emission surface 143 and second emission surface 142.

This application is entitled to and claims the benefit of Japanese Patent Application No. 2017-028917 filed on Feb. 20, 2017, the disclosure each of which including the specification, drawings and abstract is incorporated herein by reference in its entirety.

### INDUSTRIAL APPLICABILITY

A surface light source device including the light flux controlling member according to the embodiments of the present invention is applicable to a backlight of a liquid crystal display, a sign board, a commonly used illumination apparatus and the like, for example.

### REFERENCE SIGNS LIST

100 Surface light source device

110 Housing

111 Bottom plate

111a Horizontal part

111b Inclined part

112 Top plate

120 Substrate

130 Light emitting device

131 Light emitting element

132 Light flux controlling member

133 Incidence surface

134 Reflection surface

135 Emission surface

136 Flange part

137 Leg part

138 Bottom surface

139 Recess

140 First inclined surface

141 First emission surface (vertical surface)

142 Second emission surface

142a Second inclined surface

143 Third emission surface

143a Third inclined surface

144 First reflection surface

145 Second reflection surface

146 Fourth emission surface

147 Fifth emission surface

148 Fourth inclined surface

149 Fifth inclined surface

150 Light diffusion plate

CA Central axis

LA Optical axis

P1 First virtual plane

P2 Second virtual plane

L1 First virtual line

L2 Second virtual line

α Inclination angle of first inclined surface to second virtual line L2

β Inclination angle of second inclined surface and third inclined surface to second virtual line L2

γ Inclination angle of second rotation axis R2 to X axis

1. A light flux controlling member configured to control a distribution of light emitted from a light emitting element, the light flux controlling member comprising:
an incidence surface that is an inner surface of a recess and includes an inner side surface and an inner top surface, the recess being disposed on a rear side to intersect an optical axis of the light emitting element, the incidence surface being configured to allow entrance of light emitted from the light emitting element;
two reflection surfaces disposed on a front side and configured to reflect at least a part of light entered from the inner top surface in two directions that are substantially opposite to each other and are substantially perpendicular to the optical axis of the light emitting element; and
two emission surfaces disposed opposite to each other in an X-axis direction extending from a light emission center of the light emitting element along the two directions so as to sandwich the two reflection surfaces, the two emission surfaces being configured to emit, to outside, light reflected by the two reflection surfaces and light entered from the inner side surface, wherein
the emission surface includes a first inclined surface disposed in a region where the light entered from the inner side surface directly reaches, the first inclined surface being inclined toward the optical axis in a direction toward the X axis.

2. The light flux controlling member according to claim 1, wherein a lower end of the emission surface is located on the X axis, or located on the front side relative to the X axis.

3. The light flux controlling member according to claim 1, wherein the emission surface further includes a vertical surface disposed in a region where the light entered from the inner top surface and reflected by the reflection surface reaches, the vertical surface being substantially parallel to the optical axis.

4. The light flux controlling member according to claim 1,
wherein the emission surface further includes
the first inclined surface;
a first emission surface provided outside the first inclined surface in an angular range of −ψ° to ψ° (note that 0<ψ<90) with respect to a first virtual line about the X axis at a center, the first virtual line being a line that intersects the X axis and is parallel to the optical axis;
a second emission surface provided in an angular range of ψ° to 90° with respect to the first virtual line; and
a third emission surface provided in an angular range of −ψ° to −90° with respect to the first virtual line;
wherein the second emission surface includes a second inclined surface inclined toward the optical axis in the direction toward the X axis;
wherein the third emission surface includes a third inclined surface inclined toward the optical axis in the direction toward the X axis; and
wherein an inclination of the second inclined surface and the third inclined surface with respect to a second virtual line orthogonal to the X axis is greater than an inclination of the first inclined surface with respect to the second virtual line.

5. The light flux controlling member according to claim 4, wherein the first emission surface is a vertical surface that is substantially parallel to the optical axis.

6. The light flux controlling member according to claim 4,
wherein the second emission surface is composed of the second inclined surface; and
wherein the third emission surface is composed of the third inclined surface.

7. The light flux controlling member according to claim 1,
wherein the reflection surface includes:
a first reflection surface disposed on a first side with respect to a first virtual plane including the X axis and the optical axis; and
a second reflection surface disposed on a second side with respect to the first virtual plane;
wherein an average value of an inclination of the second reflection surface with respect to the X axis in a cross section C5 is greater than an average value of an inclination of the first reflection surface with respect to the X axis in a cross section C4, the cross section C4 being a cross section including the X axis and inclined to the optical axis at an arbitrary inclination angle on the first side with respect to the first virtual plane, the cross section C5 being a cross section including the X axis and inclined to the optical axis at an arbitrary inclination angle on the second side with respect to the first virtual plane;
the emission surface includes:
a fourth inclined surface disposed on the first side with respect to the first virtual plane in the first inclined surface;
a fifth inclined surface disposed on the second side with respect to the first virtual plane in the first inclined surface;
a fourth emission surface disposed outside the fourth inclined surface on the first side with respect to the first virtual plane; and
a fifth emission surface disposed outside the fifth inclined surface on the second side with respect to the first virtual plane;
wherein the fourth emission surface is substantially parallel to a second virtual plane including the optical axis and a Y axis, the Y axis being an axis that is orthogonal to the X axis and intersects the optical axis in a third virtual plane that is orthogonal to the optical axis and includes the X axis; and
the fifth emission surface is inclined toward the second virtual plane in a direction away from the X axis.

8. The light flux controlling member according to claim 7,
wherein the first reflection surface includes a part of a rotationally symmetrical surface that is rotationally symmetrical about a first rotation axis;
wherein the second reflection surface includes a part of a rotationally symmetrical surface that is rotationally symmetrical about a second rotation axis;
wherein the first rotation axis is parallel to the X axis in a cross section orthogonal to the optical axis; and
wherein the second rotation axis is inclined such that the second rotation axis is separated away from the X axis as a distance from the optical axis increases in the cross section orthogonal to the optical axis.

9. A light emitting device comprising:
a light emitting element; and
the light flux controlling member according to claim 1, wherein the incidence surface is disposed to intersect the optical axis of the light emitting element.

10. A surface light source device comprising:
a plurality of the light emitting devices according to claim 9; and
a light diffusion plate configured to allow light emitted from the light emitting devices to pass therethrough while diffusing the light.
